(19) United States
(12) Patent Application Publication
(10) Pub. No.: US 2025/0117691 A1
(43) Pub. Date: Apr. 10, 2025

(54) CENTRALIZED MODEL MAINTENANCE UTILIZING THIRD-PARTY WORKSPACES

(71) Applicant: Optum, Inc., Minnetonka, MN (US)

(72) Inventors: Vivek BHADAURIA, Bothell, WA (US); Ashish MISHRA, Kirkland, WA (US); Anand DHANDHANIA, Renton, WA (US); Vasant MANOHAR, Apex, NC (US); Carlos W. MORATO, Sammamish, WA (US)

(21) Appl. No.: 18/483,180

(22) Filed: Oct. 9, 2023

(51) Int. Cl. G06N 20/00

(52) U.S. Cl. CPC G06N 20/00

(57) ABSTRACT

Embodiments provide for improved model maintenance utilizing third-party workspaces. Some embodiments receive data artifact(s) associated with training of a machine learning model, generate model keyword(s) based on the data artifact(s), and store the machine learning model linked with the model keyword(s). Some embodiments receive data artifact(s), generate an embedded representation based on the data artifact(s), and store the embedded representation of the machine learning model in an embedding space. The stored data is then searchable to identify relevant models for deployment. Some embodiments store machine learning model(s) trained utilizing third-party workspace(s), initiate a deployed instance of a selected machine learning model, receive data artifact(s) in response to operation of the deployed instance, generate updated evaluation data associated with the deployed instance, determine that the updated evaluation data does not satisfy model maintenance threshold(s), and trigger a process that terminates access to at least the deployed instance.

### TECHNICAL FIELD

Embodiments of the present disclosure are generally directed to methodologies and mechanisms for improving centralized availability of machine learning models, and specifically to improved methodologies and mechanisms for training machine learning models via a centralized platform, storing trained machine learning models via a centralized platform, deploying individual instances of stored machine learning models via a centralized platform, and managing access to deployed instances of machine learning models via a centralized platform to ensure effective use of such deployed machine learning models.

### BACKGROUND

A user may utilize a machine learning model for any of a myriad of purposes. To best fit the particular purpose, the machine learning model may be specially trained for such purpose based on particular data, utilizing a particular machine learning model type, utilizing a particular methodology, and the like. Often, a user is relegated to use of machine learning models that they have trained themselves, and/or otherwise a user has no mechanism to accurately identify machine learning models for use for a particular purpose.

Applicant has discovered problems and/or inefficiencies with current implementations for configuring machine learning model(s), making accessible such machine learning model(s), and/or managing access to such machine learning model(s). Through applied effort, ingenuity, and innovation, Applicant has solved many of these identified problems by developing solutions embodied in the present disclosure, which are described in detail below.

### BRIEF SUMMARY

In one aspect, a computer-implemented method includes receiving, by one or more processors and automatically via at least one workspace data hook, at least one data artifact associated with training of at least a machine learning model trained utilizing at least one third-party workspace, where the at least one workspace data hook integrates with the at least one third-party workspace. The computer-implemented method also includes generating, by the one or more processors, at least one model keyword associated with the machine learning model, where the at least one model keyword is generated based on the at least one data artifact associated with the machine learning model. The computer-implemented method also includes storing, by the one or more processors, the machine learning model linked with the at least one model keyword.

In another aspect, a computer-implemented method includes receiving, by one or more processors and automatically via at least one workspace data hook, at least one data artifact associated with training of at least a machine learning model trained utilizing at least one third-party workspace, where the at least one workspace data hook integrates with the at least one third-party workspace. The computer-implemented method also includes generating, by the one or more processors, an embedded representation of the machine learning model based on the at least one data artifact. The computer-implemented method also includes storing, by the one or more processors, the embedded representation of the machine learning model in an embedding space shared with at least one other embedded representation associated with at least one other machine learning model.

In another aspect, a computer-implemented method includes storing, by one or more processors, at least one machine learning model trained utilizing at least one third-party workspace. The computer-implemented method also includes initiating, by the one or more processors, a deployed instance of a selected machine learning model, where the deployed instance of the selected machine learning model is operable via a first-party workspace. The computer-implemented method also includes receiving, by the one or more processors, at least one data artifact in response to operation of the deployed instance of the selected machine learning model via the first-party workspace. The computer-implemented method also includes generating, by the one or more processors, updated evaluation data associated with the deployed instance of the selected machine learning model based on the at least one data artifact. The computer-implemented method also includes determining, by the one or more processors, that the updated evaluation data does not satisfy at least one model maintenance threshold. The computer-implemented method also includes triggering, via the one or more processors, a process that terminates access to at least the deployed instance of the selected machine learning model in response to determining that the updated evaluation data does not satisfy the at least one model maintenance threshold.

In accordance with another aspect of the disclosure, an apparatus is provided. AN example apparatus includes at least one processor and at least one memory, the at least one memory having computer-coded instructions stored thereon that, in execution with the at least one processor, causes the apparatus to perform any one of the example computer-implemented methods described herein.

In accordance with another aspect of the disclosure, a computer program product is provided. An example computer program product includes at least one non-transitory computer-readable storage medium having computer program code stored thereon that, in execution with at least one processor, configures the computer program product for performing any one of the example computer-implemented methods described herein.

Other technical features may be readily apparent to one skilled in the art from the following figures, descriptions, and claims.

### BRIEF DESCRIPTION OF THE VARIOUS VIEWS OF THE DRAWINGS

To easily identify the discussion of any particular element or act, the most significant digit or digits in a reference number refer to the figure number in which that element is first introduced.

FIG. 1 illustrates an example computing system in accordance with at least one embodiment of the present disclosure.

FIG. 2 illustrates a schematic diagram showing a system computing architecture in accordance with at least one embodiment of the present disclosure.

FIG. 3 illustrates a dataflow diagram showing example data structures for facilitating a compute agnostic project workspace in accordance with at least one embodiment of the present disclosure.

FIG. 4 illustrates a dataflow diagram for publication in accordance with at least one embodiment of the present disclosure.

FIG. 5 illustrates a visualization of centralized model storage in a model centralization system in accordance with at least one embodiment of the present disclosure.

FIG. 6 illustrates a data architecture for model deployment in accordance with at least one embodiment of the present disclosure.

FIG. 7 illustrates a dataflow diagram for a model management process in accordance with at least one embodiment of the present disclosure.

FIG. 8 illustrates a dataflow diagram for model publication utilizing embedded representations in accordance with at least one embodiment of the present disclosure.

FIG. 9 illustrates a dataflow diagram for model publication utilizing model keywords in accordance with at least one embodiment of the present disclosure.

FIG. 10 illustrates a dataflow diagram for model searching in accordance with at least one embodiment of the present disclosure.

FIG. 11 illustrates a dataflow diagram for a termination process in accordance with at least one embodiment of the present disclosure.

FIG. 12 illustrates a flowchart depicting example operations of a process for maintaining model publication utilizing model keyword(s) in accordance with at least one embodiment of the present disclosure.

FIG. 13 illustrates a flowchart depicting example operations of a process for maintaining model publication utilizing model embedding in accordance with at least one embodiment of the present disclosure.

FIG. 14 illustrates a flowchart depicting example operations of a process for model access maintenance in accordance with at least one embodiment of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout. Moreover, while certain embodiments of the present disclosure are described with reference to predictive data analysis, one of ordinary skill in the art will recognize that the disclosed concepts may be used to perform other types of data analysis.

### I. COMPUTER PROGRAM PRODUCTS, METHODS, AND COMPUTING ENTITIES

Embodiments of the present disclosure can be implemented in various ways, including as computer program products that comprise articles of manufacture. Such computer program products can include one or more software components including, for example, software objects, methods, data structures, or the like. A software component can be coded in any of a variety of programming languages. An illustrative programming language can be a lower-level programming language such as an assembly language associated with a particular hardware architecture and/or operating system platform. A software component comprising assembly language instructions can require conversion into executable machine code by an assembler prior to execution by the hardware architecture and/or platform. Another example programming language can be a higher-level programming language that can be portable across multiple architectures. A software component comprising higher-level programming language instructions can require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages can be executed directly by an operating system or other software component without having to be first transformed into another form. A software component can be stored as a file or other data storage construct. Software components of a similar type or functionally related can be stored together such as, for example, in a particular directory, folder, or library. Software components can be static (e.g., pre-established, or fixed) or dynamic (e.g., created or modified at the time of execution).

A computer program product can include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium can include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium can also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium can also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium can also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium can include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media can be substituted for or used in addition to the computer-readable storage media described above.

As should be appreciated, various embodiments of the present disclosure can also be implemented as methods, apparatus, systems, computing devices, computing entities, and/or the like. As such, embodiments of the present disclosure can take the form of an apparatus, system, computing device, computing entity, and/or the like executing instructions stored on a non-transitory computer-readable storage medium to perform certain steps or operations. Thus, embodiments of the present disclosure can also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations can be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a non-transitory computer-readable storage medium for execution. For example, retrieval, loading, and execution of code can be performed sequentially such that one instruction is retrieved, loaded, and executed at a time. In some exemplary embodiments, retrieval, loading, and/or execution can be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

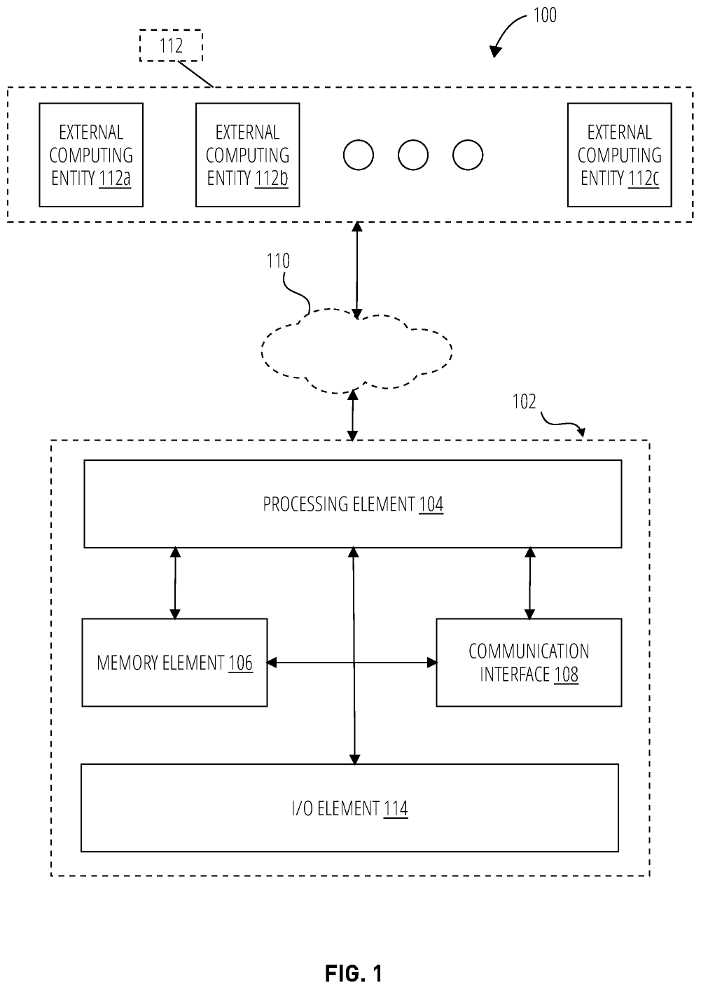

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more prediction techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more data objects from and/or to the external computing entities 112a-c to perform one or more steps/operations of one or more prediction techniques described herein.

The external computing entities 112a-c, for example, may include and/or be associated with one or more data centers. The data centers, for example, may be associated with one or more data repositories storing data that may, in some circumstances, be processed by the predictive computing entity 102 to provide dashboard(s), machine learning analytic(s), and/or the like. By way of example, the external computing entities 112a-c may be associated with a plurality of entities. A first example external computing entity 112a, for example, may host a registry for the entities. By way of example, in some example embodiments, the entities may include one or more service providers and the external computing entity 112a may host a registry (e.g., the national provider identifier registry, and/or the like) including one or more clinical profiles for the service providers. Additionally or alternatively, in some embodiments, the external computing entity 112a may include service provider data indicative of medical encounters serviced by the service provider, for example including patient data, CPT and/or diagnosis data, and/or the like. In addition, or alternatively, a second example external computing entity 112b may include one or more claim processing entities that may receive, store, and/or have access to a historical interaction dataset for the entities. In this regard, the external computing entity 112b may include such patient data, CPT and/or diagnosis data, claims data, other code data, and/or the like for any of a number of medical encounters. In some embodiments, the external computing entity 112b embodies one or more computing system(s) that support operations of an insurance or other healthcare-related entity. In some embodiments, a third example external computing entity 112c may include a data processing entity that may preprocess the historical interaction dataset to generate one or more data objects descriptive of one or more aspects of the historical interaction dataset. Additionally or alternatively, in some embodiments, the external computing entities includes an external computing entity embodying a central data warehouse associated with one or more other external computing entities, for example where the central data warehouse aggregates data across a myriad of other data sources. Additionally or alternatively, in some embodiments, the external computing entities includes an external computing entity embodying a user device or system that collect(s) user health and/or biometric data.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like may be used to control certain aspects of the operation of the predictive computing entity 102 with the assistance of the processing element 104.

As indicated, in one embodiment, the predictive computing entity 102 may also include one or more communication interfaces 108 for communicating with various computing entities such as the external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

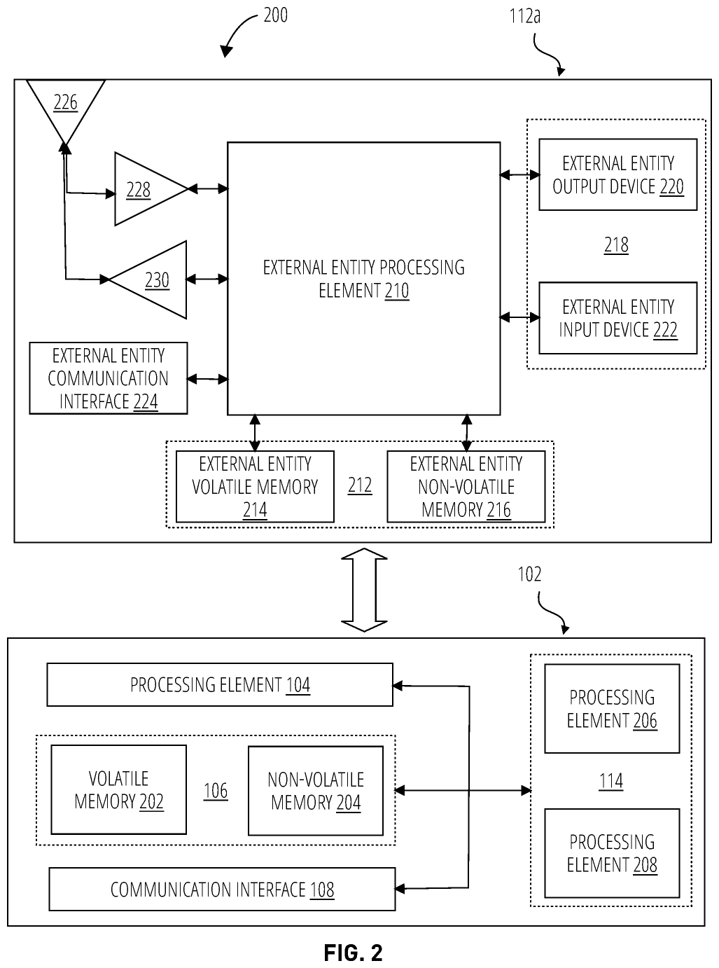

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry such as a communication bus, and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The memory element 106 may include non-volatile memory 204 (also referred to as non-volatile storage, memory, memory storage, memory circuitry and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Implementations of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established, or fixed) or dynamic (e.g., created, or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 302.9 (Wi-Fi), Wi-Fi Direct, 302.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry such as a communication bus, and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. EXAMPLE OF CERTAIN TERMS

“Canonical representation” refers to a data entity that represents a standardized representation of a machine learning project. The canonical representation may include a plurality of model attributes that describe one or more aspects of the machine learning project. For example, the canonical representation may include evaluation data for the machine learning project. In addition, or alternatively, the canonical representation may include interfaces (e.g., interactive links, pointer, API endpoints, etc.) for accessing the machine learning model and/or workspace for a portion of the machine learning model (e.g., hosted by a first-party resource and/or third-party resource, etc.).

“Compute agnostic project workspace” refers to workspace that is at least partially hosted by a first-party computing resource and/or at least one third-party computing resource. The compute agnostic project workspace may support multiple compute choices for a machine learning project including on-prem, first-party, solutions and third-party solutions, such as cloud service platforms (e.g., Kubernetes, Spark, AML, Sagemaker, Databricks, etc.). For example, the compute agnostic project workspace may aggregate data and functionality across a plurality of first-party and/or third-party workspaces to allow users (e.g., data scientists, etc.) to take advantage of different compute choices for handling different stages, workloads, and/or the like of a machine learning project from one centralized workspace, while working with consistent contracts for data access, analysis, model building, deployment, and/or the like.

“Computing resource” refers to computing platform configured to facilitate the performance of one or more computing tasks, such as data manipulation, model development, data storage, and/or the like. In some contexts a computing platform includes one or more processing devices, memory devices, and/or the like that are physically and/or wirelessly coupled and configured to collectively (and/or individually) perform the one or more computing tasks. In some contexts, a computing resource includes an operating system configured to manage and facilitate the use of the one or more processing devices, memory devices, and/or the like. In some contexts, a computing resource includes one or more local and/or remote resources configured to execute computing applications, compute services, and/or the like.

“Data artifact” refers to electronically managed data representing characteristic(s) and/or other data value(s) associated with a machine learning model, training of a machine learning model, and/or a user profile associated with operation of a machine learning model.

“Data processing task” refers to a prediction, determination, transformation, and/or other computer-implemented process that generates output data based on input data.

“Deployed instance” refers to a particular implementation of a machine learning model defined by discrete parameter(s), hyperparameter(s), and/or other data value(s) that define operation of the model. A deployed instance corresponds to a particular source machine learning model that was utilized to initiate particular data value(s) defining operation of the instance of the machine learning model.

“Deployment workspace” refers to one or more workspace(s) utilized to maintain and/or operate a deployed instance of a machine learning model. In some embodiments, a deployment workspace includes at least one first-party workspace that provides access to at least one third-party workspace.

“Drift metric data” refers to electronically managed data value(s) representing a degradation of a value representing a model accuracy or another operational parameter.

“Drift threshold” refers to electronically managed data representing a particular value that, if a corresponding value for a particular data property exceeds or falls below, indicates that a particular condition is met.

“Embedded representation” refers to electronically managed data embodying a particular representation of particular data at a lower dimensionality than the particular data being represented.

“Embedding space” refers to electronically managed data embodying any number of embedded representations.

“Evaluation data” refers to a data entity that represents one or more evaluated aspects of a machine learning project. The evaluation data may include a plurality of project quality metrics generated by the project quality routines. The project quality metrics may include one or more data quality metrics, such as data fairness, completeness, and/or the like, one or more model quality metrics, such as model fairness, overall performance, and/or the like, and/or any other metrics for evaluating a machine learning project.

“First-party computing resource” refers to a computing resource of one or more hardware, software, and/or firmware components of computing device(s) that generate, provide, or otherwise enable access to a first-party workspace. The local computing resource may include a first-party computing platform with one or more processing devices, memory devices, and/or the like that are owned, operated, and/or otherwise associated with an entity embodying a first party. The first-party computing resource, for example, may include a software platform that is executed by devices located on the premises of one or more locations associated with the first party

“First-party workspace” refers to a workspace that is hosted by a first-party computing resource. The first-party workspace may include a local file, directory, and/or the like that is hosted by one or more local computing resources associated with the first party. The first-party workspace may be configured based on an operating system of the first-party computing resource and may offer access to a plurality first-party routine sets (e.g., application programming interfaces (APIs), software development kits (SDKs), etc.) configured for the first-party computing resource.

“Keyword embedding space” refers to an embedding space that defines embedded representation(s) of any number of model keyword(s).

“Keyword generation model” refers to a machine learning model that is specially configured to generate any number of model keywords corresponding to a particular machine learning model.

“Keyword generation rule” refers to one or more computer-implemented process(es) that process data embodying or associated with a machine learning model to generate model keyword(s) based on such data. “Keyword generation rule set” refers to any number of data structure(s) that store any number of keyword generation rules.

“Machine learning model” refers to a data entity that describes parameters, hyper-parameters, and/or defined operations of a rules-based algorithm, machine learning model (e.g., model including at least one of one or more rule-based layers, one or more layers that depend on trained parameters, coefficients, and/or the like), and/or the like. The machine learning model may be configured to process input data to generate a prediction, classification, and/or any other machine learning output. The machine learning model may include one or more of any type of machine learning model including one or more supervised, unsupervised, semi-supervised, reinforcement learning models, and/or the like. In some embodiments, the machine learning model may include multiple models configured to perform one or more different stages of the joint machine learning process. The machine learning model may include one or more neural networks, deep learning models (e.g., long, short-term memory networks, recurrent neural networks, etc.), regression models, random forest models, support vector machines, and/or the like.

“Metric minimum threshold” refers to at least one data value that, if a corresponding portion of data falls below, indicates an unacceptable data drift.

“Minimum evaluation threshold” refers to at least one data value that, if one or more corresponding data value(s) for portions of evaluation data satisfy, for example by falling above or below, indicate a machine learning model does not satisfy applicable requirements for publication.

“Model centralization system” refers to one or more computing device(s) embodied in hardware, software, firmware, and/or any combination thereof, that provides access to one or more workspace(s) for training, deploying, and/or otherwise managing one or more machine learning model(s).

“Model keyword” refers to electronically managed data representing a determined characteristic associated with configuration, training, and/or operation of a machine learning model.

“Model maintenance threshold” refers to at least one data value that if not satisfied indicates that a deployed instance of a machine learning model is no longer acceptable for use.

“Model management process” refers to a computer-implemented process that enables termination of access to a particular machine learning model and/or deployed instance(s) of a machine learning model.

“Publication” refers to a computer-implemented process for storing and/or otherwise making available, via a particular centralized repository, a machine learning model or data usable to reconstruct or otherwise deploy a machine learning model.

“Publication criteria” refers to a data entity that represents one or more first-party requirements for receiving and/or providing data from a third-party workspace. The publication criteria may include one or more project quality thresholds for determining whether to accept data from a third-party workspace. The project quality thresholds, for example, may include one or more threshold requirements that are tailored to each of the project quality metrics generated for a machine learning project. For example, the project quality thresholds may include a data quality threshold for evaluating a data quality metric for a machine learning project. As another example, the project quality thresholds may include a model quality threshold for evaluating a model quality metric for a machine learning project. In some embodiments, the publication criteria establish one or more different sets of first-party requirements for publishing portions of a machine learning project to different privilege levels of the first-party. By way of example, the publication criteria may include a first set of project quality thresholds for publishing data from a third-party workspace to the compute agnostic project workspace. In addition, or alternatively, the publication criteria may include a second set of project quality thresholds for publishing data from a third-party workspace to a unified project repository. The second set of project quality thresholds may be stricter than the first set of project quality thresholds.

“Query embedded location” refers to electronically managed data that embodies a position of an embedded representation in a particular embedding space.

“Search query” refers to electronically managed data that defines one or more data parameter(s) utilized to search a data repository.

“Selected machine learning model” refers to electronically managed data indicating a machine learning model selected by a particular user for use, training, and/or the like.

“Shared” with respect to multiple embedded representations refers to a common embedding space within which multiple embedded representations may be projected.

“Stored machine learning model” refers to electronically managed data embodying or that is usable to reconstruct or otherwise represent a machine learning model, where such data is maintained by a model centralization system.

“Third-party computing resource” refers to one or more hardware, software, and/or firmware components of computing device(s) that generate, provide, or otherwise enable access to a third-party workspace and that are remote from a system or computing device that accesses the third-party workspace. The remote computing resource may include a third-party computing platform with one or more processing devices, memory devices, and/or the like that are owned, operated, and/or otherwise associated with a third-party. The third-party computing resource, for example, may include a software platform (e.g., Amazon Web Services (AWS), Microsoft Azure, Google Cloud Platform (GCP), etc.) that is executed by a cloud services provider. In some examples, the third-party computing resource may include platform services that may be accessible to a first party.

“Third-party workspace” refers to a workspace that is hosted by a third-party computing resource. The third-party workspace may include a remote file, directory, and/or the like that is hosted by one or more third-party computing resources of a third-party. The third-party workspace may be configured based on an operating system of the third-party computing resource and may offer access to a plurality of third-party routine sets (e.g., APIs, SDKs, etc.) configured for the third-party computing resource.

“Updated evaluation data” refers to evaluation data that is received based on use of a deployed instance of a particular stored machine learning model.

“User profile” refers to electronically managed data that corresponds to a particular account, credentials, or other data providing access to functionality of a model centralization system.

“Workspace” refers to a unit of computing space and/or processing power that is facilitated by a computing resource. A workspace may include a file, directory, and/or the like that allows a user to store, develop, test, and/or evaluate at least a portion of a machine learning-based project. For example, a workspace may include a portion of digital storage for storing training data, source code files, machine learning parameters and/or weights, and/or the like. As another example, a workspace may include a portion of compute power (e.g., processing power, etc.) for performing one or more computing tasks, and/or the like. In some examples, a workspace may incorporate one or more functionalities of a host computing resource. For example, a host computing resource may include and/or have access to one or more host routine sets, such as application programming interfaces (APIs), software development kits (SDKs), and/or the like. A workspace hosted by a host computing resource may have access to at least a portion of the host routine sets.

“Workspace data hook” refers to an application programming interface or other computer application-based form of communication that enables a software application to retrieve particular data from within a workspace maintained at least in part by one or more other computing resource(s). In some embodiments, a workspace data hook enables a first-party workspace to retrieve particular data from at least one corresponding third-party workspace.

### IV. OVERVIEW, TECHNICAL IMPROVEMENTS, AND TECHNICAL ADVANTAGES

Embodiments of the present disclosure provide centralized machine learning model management techniques via a single computing platform that provide various improvements over traditional machine learning model management. The machine learning model management techniques may be leveraged to provide improved storage and access to any number of machine learning models for any number of users. In this regard, embodiments of the present disclosure include improved model publication processes that facilitate improved storage and maintenance of machine learning model data, and/or supporting search and/or related metadata, in a centralized system accessible to one or more user(s) for subsequent model training and/or individual instance deployment for use in completing one or more data processing task. Additionally or alternatively, embodiments of the present disclosure include improved model searching techniques based on the improved model storage techniques via the centralized system, for example utilizing particular improved keyword processing and/or improved embedding processing to resolve improved searches of stored machine learning models in the centralized system. Additionally or alternatively, embodiments of the present disclosure include improved model management processes that configure access to the stored machine learning models in the centralized system.

The centralized system embodies a model centralization system that is specially configured to provide each of such improved processes. For example, a model centralization system may be specially configured to enable configuration of at least one first-party workspace that provides access to training a machine learning model, publishing the machine learning model for storage, searching for a stored machine learning model to deploy, and/or deploying or using a deployed instance of a stored machine learning model, or any combination thereof. In some embodiments, the model centralization system is specially configured to provide access to third-party workspace(s) embodied by external computing device(s), system(s), and/or the like during development, training, and/or other configuration of a machine learning model, and/or for further deployment and/or use of a particular deployed instance of a machine learning model. In this regard, some such embodiments of the present disclosure enable improved performance of machine learning model training and/or deployment by enabling such functions to be off-loaded to such external systems, for example that may include improved computing power or otherwise be specially configured to enable such operation(s) in an efficient manner. Additionally or alternatively, some such embodiments provide for improved searching of stored machine learning models in a more efficient and accurate manner utilizing the data resulting from such data hooks during configuration of each such stored machine learning model in the third-party workspace, allowing for such searches to be performed both more efficiently and with improved accuracy. Additionally or alternatively still, some such embodiments leverage particular data hook(s) that integrate with such third-party workspace(s) to enable provisioning, data tracking and traceability, and/or other processes for machine learning model storage, searching, maintenance, and/or other management automatically, thus reducing efficiency loss and errors conventionally introduced by reliance on user action and/or user-submitted data for such purposes.

### V. EXAMPLE SYSTEM OPERATIONS

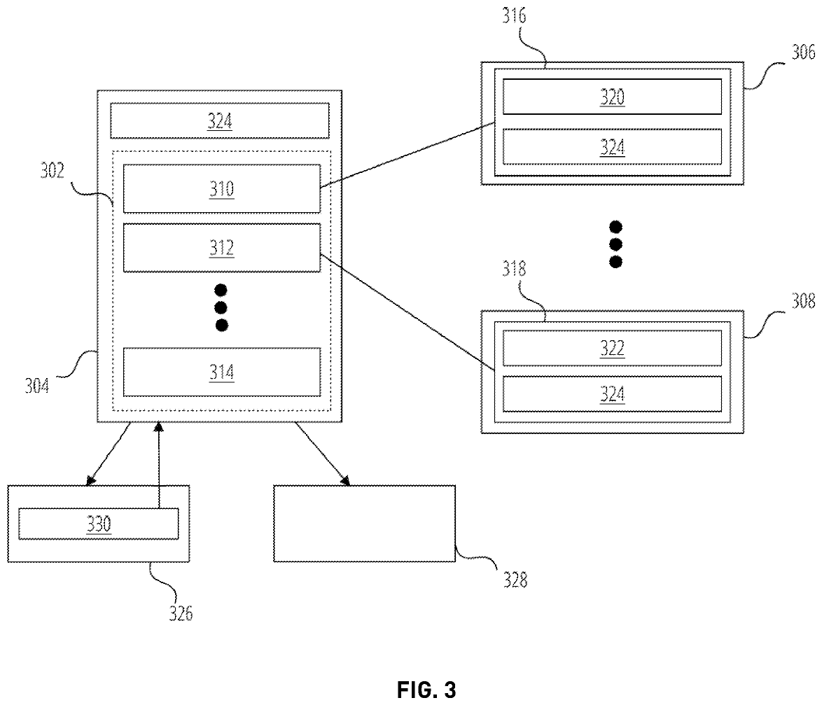

FIG. 3 is a dataflow diagram 300 showing example data structures for facilitating a compute agnostic project workspace in accordance with some embodiments discussed herein. The dataflow diagram 300 depicts a set of data structures and computing entities for generating a centralized workspace for leveraging various machine learning development, evaluation, and validation functionalities across a plurality of disparate computing resources. The centralized workspace may be a compute agnostic project workspace 302 that is provided by a first-party computing resource 304. The first-party computing resource 304 may facilitate access to a plurality of different machine learning tools offered by third-party computing resources to provide a cloud agnostic end-to-end machine learning environment where users may work with any of a plurality of different combinations of third-party computing resources, such as the first third-party computing resource 306 and/or the second third-party computing resource 308. In some examples, the first third-party computing resource 306 and the second third-party computing resource 308 may be different third-party computing resources.

In some embodiments, a computing resource is a computing platform configured to facilitate the performance of one or more computing tasks, such as data manipulation, model development, data storage, and/or the like. A computing platform may include one or more processing devices, memory devices, and/or the like that are physically and/or wirelessly coupled and configured to collectively (and/or individually) perform the one or more computing tasks. A computing resource may include an operating system configured to manage and facilitate the use of the one or more processing devices, memory devices, and/or the like. A computing resource may include one or more local and/or remote resources configured to execute computing applications, compute services, and/or the like.

In some embodiments, the first-party computing resource 304 is a local computing resource. The local computing resource may include a first-party computing platform with one or more processing devices, memory devices, and/or the like that are owned, operated, and/or otherwise associated with a first party. The first-party computing resource, for example, may include a software platform that is executed by devices located on the premises (e.g., on-prem devices) of one or more locations associated with the first party.

In some embodiments, a third-party computing resource, such as the first third-party computing resource 306 and/or the second third-party computing resource 308, is a remote computing resource. The remote computing resource may include a third-party computing platform with one or more processing devices, memory devices, and/or the like that are owned, operated, and/or otherwise associated with a third-party. The third-party computing resource, for example, may include a software platform (e.g., Amazon Web Services (AWS), Microsoft Azure, Google Cloud Platform (GCP), etc.) that is executed by a cloud services provider. In some examples, the third-party computing resource may include platform services that may be accessible to a first party. As an example, the first third-party computing resource 306 may be a first software platform and the second third-party computing resource 308 may be a second software platform.

Each of the first-party computing resource 304, the first third-party computing resource 306, and the second third-party computing resource 308 may be configured to operate according to different computing architectures, operating systems, APIs, and/or the like. Each computing resource, for example, may be a distinct computing node that may be configured to operate in a manner that may be incompatible with the one or more other computing resources. Traditionally, machine learning platforms address compatibility issues by constraining the compute choices for a machine learning project. However, this may lead to fragmentation and increases in cognitive overload. To address these concerns, some of the embodiments of the present disclosure facilitate a compute agnostic project workspace 302 that enables a user to leverage the functionalities of multiple, potentially incompatible, computing platforms from one centralized project workspace.

In some embodiments, a workspace is a unit of computing space and/or processing power that is facilitated by a computing resource. A workspace may include a file, directory, and/or the like that allows a user to store, develop, test, and/or evaluate at least a portion of a machine learning-based project. For example, a workspace may include a portion of digital storage for storing training data, source code files, machine learning parameters and/or weights, and/or the like. As another example, a workspace may include a portion of compute power (e.g., processing power, etc.) for performing one or more computing tasks, and/or the like.

In some examples, a workspace may incorporate one or more functionalities of a host computing resource. For example, a host computing resource may include and/or have access to one or more host routine sets, such as application programming interfaces (APIs), software development kits (SDKs), and/or the like. A workspace hosted by a host computing resource may have access to at least a portion of the host routine sets. By way of example, the host computing resource for a workspace may include the first-party computing resource 304, the first third-party computing resource 306, and/or the second third-party computing resource 308.

In some embodiments, a first-party workspace is a workspace that is hosted by the first-party computing resource 304. The first-party workspace may include a local file, directory, and/or the like that is hosted by one or more local computing resources of a first party. The first-party workspace may be configured based on an operating system of the first-party computing resource and may offer access to a plurality of first-party routine sets 324 configured for the first-party computing resource.

In some embodiments, a third-party workspace, such as the first third-party workspace 316, the second third-party workspace 318, and/or the like, is to a workspace that is hosted by a respective third-party computing resource. For example, the first third-party workspace 316 may be hosted by the first third-party computing resource 306, the second third-party workspace 318, may be hosted by the second third-party computing resource 308, and/or the like. A third-party workspace may include a remote file, directory, and/or the like that is hosted by the respective third-party computing resources. The first third-party workspace 316 may be configured based on an operating system of the first third-party computing resource 306 and may offer access to a plurality of first third-party routine sets 320 (e.g., APIs, SDKs, etc.) configured for the first third-party computing resource 306. The second third-party workspace 318 may be configured based on an operating system of the second third-party computing resource 308 and may offer access to a plurality of second third-party routine set 322 (e.g., APIs, SDKs, etc.) configured for the second third-party computing resource 308.

In some embodiments, the first-party computing resource 304 is configured to generate a compute agnostic project workspace 302 to leverage the various functionalities provided by one or more third-party computing resources. The compute agnostic project workspace 302 may provide an interface between the first-party computing resource 304 and the third-party computing resources to facilitate the use of a plurality of different routine sets, such as the first-party routine set 324, the first third-party routine set 320, the second third-party routine set 322, and/or the like from one central workspace.

In some embodiments, the compute agnostic project workspace is a workspace that is at least partially hosted by the first-party computing resource 304 and/or at least one third-party computing resource. The compute agnostic project workspace 302 may support multiple compute choices for a machine learning project including on-prem, first-party, solutions and third-party solutions, such as cloud server platforms (e.g., Kubernetes, Spark, AML, Sagemaker, Databricks, etc.). For example, the compute agnostic project workspace 302 may aggregate data and functionality across a plurality of first-party and/or third-party workspaces to allow users (e.g., data scientists, etc.) to take advantage of different compute choices for handling different stages, workloads, and/or the like of a machine learning project from one centralized workspace, while working with consistent contracts for data access, analysis, model building, deployment, and/or the like.

In some examples, the compute agnostic project workspace 302 may be hosted by the first-party computing resource 304. The compute agnostic project workspace 302 may include cloud agnostic routine sets, such as APIs, SDKs, and/or the like, that communicatively couple the compute agnostic project workspace 302 to each of a plurality of third-party workspaces identified for a machine learning project. In this way, the compute agnostic project workspace 302 may provide access to novelty features available through different third-party computing resources (e.g., cloud providers, etc.) and mix and match the first third-party computing resources 306 based on the requirements of a machine learning project. By way of example, the compute agnostic project workspace 302 may provide access to a first third-party workspace 316 (e.g., an AWS Sagemaker Canvas, etc.) to leverage specific functionality (e.g., first third-party routine set 320, etc.) for training a machine learning model and a second third-party workspace 318 (e.g., Azure Blob Storage, etc.) to leverage a different set of functionality (e.g., second third-party routine set 322) for storing training data.

The compute agnostic project workspace 302 may be generated based on configuration data. For example, the first-party computing resource 304 may be configured to generate the compute agnostic project workspace 302 in response to a first-party workspace request 330 that includes configuration data for the compute agnostic project workspace 302.

In some embodiments, the first-party workspace request 330 refers to a data entity that represents a user intention for configuring a first-party workspace at the first-party computing resource 304. In some examples, the first-party workspace request 330 may include a request to configure the compute agnostic project workspace 302. The first-party workspace request 330 may include configuration data that identifies one or more project attributes, one or more third-party computing resources, one or more user subscriptions, and/or any other data associated with a first-party computing resource 304, a third-party computing resource, and/or a machine learning project.

In some embodiments, the first-party workspace request 330 identifies a third-party computing resource for one or more stages of a machine learning project. By way of example, a machine learning project may include a data preparation stage, a model experiment stage, a model review stage, and/or model deployment stage for a machine learning model. The first-party workspace request 330 may identify a first third-party computing resource 306 for a data preparation stage, a second third-party computing resource 308 for a model experiment stage, and/or the like. The first third-party computing resource 306, for example, may include a first set of functionality (e.g., first third-party routine set 320, etc.) that may be leveraged to prepare a training dataset for a machine learning model, whereas the second third-party computing resource 308 may include a second set functionality (e.g., second third-party routine set 322) that may be leveraged to optimize a machine learning model over a prepared training dataset.

In some embodiments, a machine learning project is a data entity that represents one or more machine learning models that are configured to perform a machine learning task and/or one or more datasets used to generate, evaluate, and/or refine the machine learning models. By way of example, the machine learning project may include one or more model architectures, parameters, and/or weights that may be configured to generate one or more trained machine learning models. In addition, or alternatively, the machine learning project may include one or more training, testing, and/or validation datasets for generating the one or more trained machine learning models.

In some embodiments, a machine learning model is a data entity that describes parameters, hyper-parameters, and/or defined operations of a rules-based algorithm, machine learning model (e.g., model including at least one of one or more rule-based layers, one or more layers that depend on trained parameters, coefficients, and/or the like), and/or the like. The machine learning model may be configured to process input data to generate a prediction, classification, and/or any other machine learning output. The machine learning model may include one or more of any type of machine learning model including one or more supervised, unsupervised, semi-supervised, reinforcement learning models, and/or the like. In some embodiments, the machine learning model may include multiple models configured to perform one or more distinct stages of a joint machine learning process. The machine learning model may include one or more neural networks, deep learning models (e.g., long, short-term memory networks, recurrent neural networks, etc.), regression models, random forest models, support vector machines, and/or the like.

In some embodiments, the first-party computing resource 304 receives a first-party workspace request 330 for a machine learning project that involves one or more machine learning models. The first-party computing resource 304 may receive the first-party workspace request 330 from a user, computing entity, and/or the like. The first-party workspace request 330 may be indicative of a third-party computing resource, such as the first third-party computing resource 306 and/or the second third-party computing resource 308.

In some embodiments, the first-party workspace request 330 is received from a user through a configuration interface 326 provided by the first-party computing resource 304. For example, the configuration interface 326 may include one or more selection interfaces. The first-party workspace request 330 may include selection input, from one or more of the selection interfaces, which identifies one or more portions of the configuration data for a compute agnostic project workspace 302.

In some embodiments, a configuration interface 326 is a user interface for facilitating a first-party workspace request 330. The configuration interface 326 may be hosted by the first-party computing resource 304 to facilitate the input of one or more configuration parameters for the compute agnostic project workspace 302. For instance, the configuration interface 326 may include one or more selection interfaces that respectively include one or more selection widgets for providing a selection input indicative of a configuration parameter for the compute agnostic project workspace 302. By way of example, a first selection interface may include one or more interactive compute selection widgets indicative of a first plurality of third-party computing resources for model configuration. As another example, a second selection interface may include one or more interactive data selection widgets indicative of a second plurality of third-party computing resources for data configuration.

In some examples, the first-party computing resource 304 may receive a first selection input from a first selection interface of the configuration interface 326 hosted by the first-party computing resource 304. The first selection input may identify the first third-party computing resource 306 for configuring a machine learning model. The first third-party computing resource 306, for example, may be selected for training one or more machine learning models of the machine learning project. In some examples, the first-party computing resource 304 may receive a second selection input from a second selection interface of the configuration interface 326 hosted by the first-party computing resource 304. The second selection input may identify the second third-party computing resource 308 for configuring a training dataset for a machine learning model. The second third-party computing resource 308, for example, may be selected for processing a dataset for training one or more machine learning models of the machine learning project.

In some embodiments, the first-party computing resource 304 may provide the first selection interface and/or the second selection interface for display to a user. The first selection interface may include one or more interactive compute selection widgets that identify a plurality of available third-party computing resources for model configuration. The second selection interface may include one or more interactive data selection widgets that identify a plurality of available third-party computing resources for data configuration. In some examples, the plurality of available third-party computing resources may be dynamically determined based on one or more attributes of the machine learning project and/or a user subscription associated with the user.

In response to the first-party workspace request for a machine learning project, the first-party computing resource 304 may generate the compute agnostic project workspace 302 hosted by the first-party computing resource 304, initiate the generation of a third-party workspace hosted by one or more third-party computing resources based on the configuration data, and/or initiate a configuration of a first-party routine set within the third-party workspace. By way of example, the first-party computing resource 304 may initiate the generation of at least one third-party workspace for each third-party computing resource identified by the configuration data.

In some examples, the first-party workspace request may be indicative of a plurality of third-party computing resources. The first-party computing resource 304 may initiate the generation of a respective third-party workspace for each of the plurality of third-party computing resources. For instance, the configuration data may identify the first third-party computing resource 306 and the second third-party computing resource 308. In such a case, the first-party computing resource 304 may initiate the generation of the first third-party workspace 316 and the second third-party workspace 318.

In some embodiments, the first-party workspace request is associated with one or more user subscriptions. The one or more user subscriptions may be indicative of one or more resource permissions for a third-party computing resource. The one or more resource permissions, for example, may be indicative of an amount of allocated space for a user, an amount of allocated compute power for the user, and/or the like. In some examples, a third-party workspace may be generated using one or more user subscriptions for the third-party workspace.

In some embodiments, the user subscription is a data entity that describes one or more third-party privileges for a user. A user subscription may identify one or more third-party credentials, third-party allowances (e.g., space, processing power, etc.), and/or the like, that may be leveraged by the first-party computing resource 304 to generate a third-party workspace for a user and/or group of users. By way of example, the user subscription may include one or more cloud computing privileges for allocating space, computing power, and/or the like from a third-party computing resource to a machine learning project.

In some embodiments, the first-party computing resource 304 leverages the one or more user subscriptions to initiate the generation of a third-party workspace at a third-party computing resource. For example, the first-party computing resource 304 may leverage user subscriptions for a first third-party computing resource 306 to initiate the generation of the first third-party workspace 316. As another example, the first-party computing resource 304 may leverage user subscriptions for the second third-party computing resource 308 to initiate the generation of the second third-party workspace 318.

The user subscriptions, for example, may be leveraged to configure the connectivity, network security, and/or infrastructure parameters for the third-party workspace. The user subscriptions may correspond to a user and/or a group of users associated with a first-party workspace request 330. In some examples, a user and/or a user group may be associated with a profile with the first party that may identify the user subscriptions. In some examples, the user profile may at least partially control a particular first-party workspace to enable one or more different user subscriptions for the user and/or user group. In this manner, the first party may authorize the use and/or the extent of use of the third-party computing resources.

In some embodiments, the first-party computing resource 304 initiates the configuration of the first-party routine set 324 within each of the third-party workspaces. For example, the first-party computing resource 304 may initiate a configuration of the first-party routine set 324 within the respective third-party workspace for each of the plurality of third-party computing resources to facilitate communication between the first-party computing resource 304 and each of the plurality of third-party computing resources.

In some embodiments, the first-party routine set 324 is a data entity that represents one or more computing functionalities corresponding to a first party. For example, the first-party routine set 324 may include a first-party API that defines one or more interface calls between a first-party workspace and a first-party server. In some examples, the first-party routine set 324 may include a first-party SDK that provides one or more development tools and/or functionalities for the configuration of a machine learning project.

In some examples, the first-party routine set 324 may define a plurality of webhooks for facilitating communication between the first-party computing resource 304 and the third-party computing resources. The plurality of webhooks may include callback functions that automatically initiate the transfer of data between the first-party computing resource 304 and the third-party computing resources. The callback functions may be event-driven. For example, webhooks may initiate the transfer of data between the first-party computing resource 304 and the third-party computing resources in response to one or more changes within a respective third-party workspace, such as a coding modification, a parameter or weighting modification, a dataset modification, and/or the like. In some examples, the webhooks are triggered by one or more other functions of the first-party routine set 324, such as a publication request routine, and/or the like.

During configuration, the first-party computing resource 304 may automatically install the first-party routine set 324 within a third-party workspace to initiate the transfer of data from the third-party workspace to the compute agnostic project workspace 302. In this manner, the compute agnostic project workspace 302 may aggregate data across a plurality of different workspaces hosted by various different third-party computing resources.

In some embodiments, the compute agnostic project workspace 302 includes a plurality of sub-workspaces that are tailored to one or more distinct stages of a machine learning project. In some examples, each sub-workspace may be configured to aggregate data from one or more different third-party computing resources to facilitate a particular stage of the machine learning project. For example, a sub-workspace may be configured for a stage of the machine learning project handled by the first party and/or a stage of the machine learning project handled by a third-party. A first sub-workspace 310, for instance, may be configured for a first stage (e.g., data preparation stage, etc.) of the machine learning project handled by the first third-party computing resource 306 through the first third-party workspace 316. A second sub-workspace 312 may be configured for a second stage (e.g., model experiment stage, etc.) of the machine learning project handled by the second third-party computing resource 308 through the second third-party workspace 318. A third sub-workspace 314 may be configured for a third stage (e.g., a model review stage, etc.) handled by the first-party computing resource 304 through a first-party workspace.

In some embodiments, a sub-workspace is a section of a workspace. For example, a workspace, such as the compute agnostic project workspace 302, may include a plurality of sections defined by a machine learning project workflow. The workspace may include a sub-workspace for each section of the machine learning project workflow. By way of example, a machine learning project workflow may include a configuration stage, a data preparation stage, a model experiment stage, a model review stage, a model deployment stage, and/or the like. A workspace may include the first sub-workspace 310 that corresponds to the data preparation stage, the second sub-workspace 312 that corresponds to the model experiment stage, a third sub-workspace 314 that corresponds to the model review stage, a fourth sub-workspace that corresponds to the model deployment stage, and/or the like.

In some embodiments, a sub-workspace corresponds with a third-party workspace. As an example, the first sub-workspace 310 may correspond to the first third-party workspace 316 and the second sub-workspace 312 may correspond to the second third-party workspace 318. Using the first-party routine set 324 (e.g., one or more webhooks thereof), each sub-workspace may aggregate data from and/or initiate commands to a corresponding third-party workspace that is hosted by a third-party computing resource. The aggregated data and/or initiated commands may be provided to/from a user through the compute agnostic project workspace 302 to provide a holistic view and/or control over a machine learning project that is developed, managed, and/or refined across a plurality of disparate third-party computing resources.

In some embodiments, each third-party workspace has access to particular third-party routine sets provided by a respective third-party computing resource. For example, the first third-party workspace 316 may have access to one or more first third-party routine sets 320 that are provided and/or compatible within the first third-party workspace 316. The first third-party routine set 320 may be leveraged within the first third-party workspace 316 to configure at least a portion of a machine learning project (e.g., a data preparation stage, etc.). As another example, the second third-party workspace 318 may have access to one or more second third-party routine sets 322 that are provided and/or compatible within the second third-party workspace 318. The second third-party routine set 322 may be leveraged within the second third-party workspace 318 to configure at least a portion of the machine learning project.

In some embodiments, the third-party routine set is a data entity that represents one or more computing functionalities corresponding to a third-party computing resource. For example, the third-party routine set may include a third-party API that defines one or more interface calls between a third-party workspace and a third-party server. In some examples, the third-party routine set may include a third-party SDK that provides one or more development tools and/or functionalities for the configuration of at least a portion of a machine learning project.

In some embodiments, at least a portion of a machine learning project may be developed, refined, evaluated, and/or deployed from a third-party workspace using a third-party routine set of the third-party workspace and the first-party routine set 324. For example, by controlling the configuration of the third-party workspaces, the first-party computing resource 304 may automatically augment the functionalities of each third-party workspace with the first-party routine set 324. In this way, a first-party routine from the first-party routine set 324 may be executed from the compute agnostic project workspace 302 (e.g., through a first-party command line interface (CLI), etc.) and/or a respective third-party workspace (e.g., through a third-party CLI, etc.).

In some embodiments, the first-party routine set 324 includes a plurality of first-party routines that are accessible through one or more interfaces (e.g., first-party CLIs, user interfaces, etc.) of the compute agnostic project workspace 302. In some examples, a call to a particular first-party routine may depend on an interface that facilitated the call. For example, a publication request routine may be called from an interface corresponding to one or more of the sub-workspaces of the compute agnostic project workspace. The publication request routine may automatically incorporate the location from which it was called as a parameter for facilitating a publication request. By way of example, a publication request routine called from an interface corresponding to a first sub-workspace 310 may initiate a publication action at the corresponding first third-party workspace 316, whereas a publication request routine called from an interface corresponding to the second sub-workspace 312 may initiate a publication action at the corresponding second third-party workspace 318.

In some embodiments, each sub-workspace of the compute agnostic project workspace 302 is associated with a corresponding user interface. For instance, the first sub-workspace 310 and the first third-party workspace 316 may be associated with a first stage (e.g., the data preparation stage, etc.) of the machine learning project. The first sub-workspace 310 may be associated with a first project interface corresponding to the first stage. The first project interface may include data associated with the first stage and/or one or more interactive third-party links to the first third-party workspace 316. One or more of the interactive third-party links may call a first-party routine to initiate an action at the first third-party workspace 316. In some examples, each sub-workspace of the compute agnostic project workspace 302 may include an interactive third-party link for initiating the performance of an action at respective third-party workspaces.

In some embodiments, the first-party computing resource 304 may receive user input indicative of a selection of at least one of the one or more interactive third-party links from a respective sub-workspace. In response to the user input, the first-party computing resource 304 may initiate, via the first-party routine set 324, the performance of a computing action at the respective third-party workspace. The computing action may include any of a plurality of actions facilitated by the first-party routine set 324. As some examples, the computing action may include an access request for accessing a respective third-party workspace, a publication request for publishing at least a portion of the machine learning project to the compute agnostic project workspace 302 and/or a unified repository, an evaluation request for evaluating one or more aspects of the machine learning project hosted by a respective third-party workspace, and/or the like.

In some embodiments, the first-party routine set defines a plurality of first-party routines for managing and evaluating aspects of a machine learning project from one centralized workspace. The plurality of first-party routines may include any number and/or any type of routine depending on the requirements of the first party. For instance, the first-party routines may include data evaluation and/or fairness routines that evaluate whether a machine learning project complies with one or more first-party standards. In some examples, the first-party routines may restrict the use and/or visibility of an aspect of a project based on evaluation measures implemented by the first-party routines. For instance, the first-party routines may include a publication request routine for publishing a portion of a machine learning project from a third-party workspace to one or more repositories provided by the first-party computing resource 304. In some examples, the publication request routine may leverage one or more project quality routines to enforce standardized publication criteria established by the first party.

In some embodiments, a publication request routine is a data entity that represents a particular computing functionality implemented by the first-party routine set 324. The publication request routine may initiate the transfer of data from a third-party workspace to the compute agnostic project workspace 302 and/or another memory location of the first-party computing resource 304. By way of example, the publication request routine may trigger a webhook (e.g., a programmable intermediary, etc.) of a first-party routine set 324 installed within a third-party workspace to relay data from the third-party workspace to the compute agnostic project workspace 302.

In some embodiments, the first-party computing resource 304 receives, via the first-party routine set 324, a publication request. The publication request may be initiated and/or received from the compute agnostic project workspace 302 (e.g., a sub-workspace thereof). In addition, or alternatively, the publication request may be initiated and/or received from a third-party workspace of a third-party computing resource. The publication request may include a request generated in response to a call to a publication request routine of the first-party routine set 324.

In response to the publication request, the first-party computing resource 304 may generate evaluation data for at least an aspect of a machine learning project within a third-party workspace by initiating the performance of one or more project quality routines from the first-party routine set 324 within the third-party workspace.

In some embodiments, project quality routines are data entities that represent particular computing functionalities implemented by a first-party routine set 324. The project quality routines may include one or more verification functions for verifying one or more aspects of a machine learning project. By way of example, the project quality routines may include one or more scanning functions for verifying the completeness of a project, one or more compiling functions for verifying the executability of the project, one or more data evaluation functions for verifying the data quality for a project, one or more model evaluation functions for verifying the model performance for a project, and/or the like. In some examples, the project quality routines may be included within a first-party routine set 324 installed within a third-party workspace to allow a first-party computing resource 304 to check project quality at the third-party workspace. By way of example, a call to a publication request routine may initiate the performance of the project quality routines within a third-party workspace to generate evaluation data for the machine learning project. In some examples, the publication request routine may be configured to relay data from the third-party workspace based on the evaluation data.

In some embodiments, evaluation data is a data entity that represents one or more evaluated aspects of a machine learning project. The evaluation data may include a plurality of project quality metrics generated by the project quality routines. The project quality metrics may include one or more data quality metrics, such as data fairness, completeness, and/or the like, one or more model quality metrics, such as model fairness, overall performance, and/or the like, and/or any other metrics for evaluating a machine learning project.

In some embodiments, in response to publication request, the first-party computing resource 304 modifies the compute agnostic project workspace 302 based on a comparison between evaluation data for an aspect of a machine learning project and one or more publication criteria.

In some embodiments, publication criteria are a data entity that represents one or more first-party requirements for receiving and/or providing data from a third-party workspace. The publication criteria may include one or more project quality thresholds for determining whether to accept data from a third-party workspace. The publication criteria, for example, may include one or more project quality thresholds indicative of an acceptable publication threshold for each of the project quality metrics. The project quality thresholds, for example, may include one or more threshold requirements that are tailored to each of the project quality metrics generated for a machine learning project. For example, the project quality thresholds may include a data quality threshold for evaluating a data quality metric for a machine learning project. As another example, the project quality thresholds may include a model quality threshold for evaluating a model quality metric for a machine learning project.

In some embodiments, the publication criteria establish one or more different sets of first-party requirements for publishing portions of a machine learning project to different privilege levels of the first party. By way of example, the publication criteria may include a first set of project quality thresholds for publishing data from a third-party workspace to the compute agnostic project workspace 302. In addition, or alternatively, the publication criteria may include a second set of project quality thresholds for publishing data from a third-party workspace to a unified project repository hosted by the first-party computing resource 304. The second set of project quality thresholds may be stricter than the first set of project quality thresholds such that the project is held to a higher standard as the level of visibility for a project increases.

In some embodiments, the compute agnostic project workspace 302 is modified by pulling data from a third-party workspace to populate a sub-workspace of the compute agnostic project workspace 302. For example, in response to a publication request initiated from the first sub-workspace and/or a corresponding first third-party workspace 316, the first-party computing resource 304 may cause the first third-party workspace 316 to generate evaluation data. In the event that the evaluation data satisfies publication criteria for publishing data from the first third-party workspace 316 to the compute agnostic project workspace 302, the first-party computing resource 304 may receive, retrieve, and/or otherwise accept project data from the first third-party workspace 316. The project data may include a state of at least one aspect of the machine learning project that may be reflective of one or more characteristics for a particular stage of the machine learning project.

In addition, or alternatively, in some embodiments, the compute agnostic project workspace 302 is modified by generating and/or modifying a canonical representation 328 of the machine learning project. For example, in response to determining that the machine learning project satisfies publication criteria for publishing data from a respective third-party workspace to a canonical representation 328 of the machine learning project, the first-party computing resource 304 may generate the canonical representation 328 of the machine learning project that represents one or more model attributes for the machine learning project. The one or more model attributes, for example, may include one or more model quality metrics for the machine learning project.

In some embodiments, the canonical representation 328 is a data entity that represents a standardized representation of a machine learning project. The canonical representation 328 may include a plurality of model attributes that describe one or more aspects of the machine learning project. For example, the canonical representation 328 may include evaluation data for the machine learning project. In addition, or alternatively, the canonical representation 328 may include interfaces (e.g., interactive links, pointers, API endpoints, etc.) for accessing the machine learning model and/or workspace for a portion of the machine learning model (e.g., hosted by a first-party resource and/or third-party resource, etc.).

As described herein, the first-party computing resource 304 may generate a compute agnostic project workspace 302 that facilitates the configuration, development, refinement, review, and deployment of a machine learning project across a plurality of distinct, incompatible, third-party computing resources. To do so, the first-party computing resource 304 provides a plurality of interfaces for managing and configuring a plurality of disparate third-party workspaces. One such interface includes the configuration interface 326.

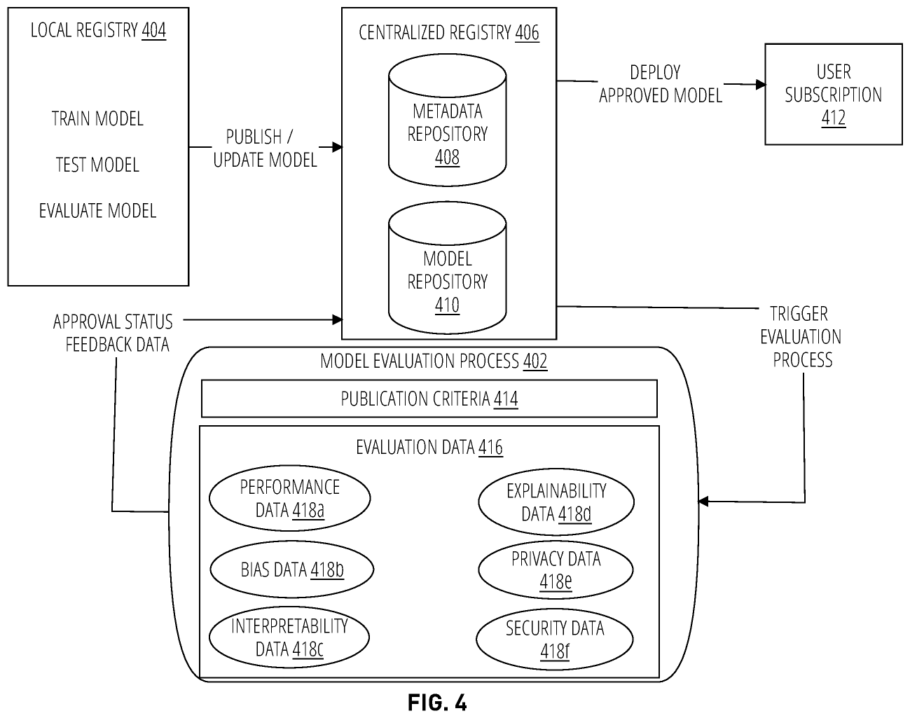

FIG. 4 illustrates a dataflow diagram for publication in accordance with at least one embodiment of the present disclosure. Specifically, FIG. 4 depicts a dataflow for publication between at least one local registry 404 and a centralized registry 406, where the centralized registry 406 is accessible to initiate deployed instances of stored machine learning model(s) for accessing via a particular user subscription, such as user subscription 412. In this regard, some embodiments may be specially configured in accordance with the depicted dataflow to store any number of machine learning model(s) and initiate deployed instance(s) of such stored machine learning model(s) as further described herein. In some embodiments, the centralized registry 406 embodies or is included in a model centralization system that provides at least such functionality.

As illustrated, the dataflow includes a local registry 404. Within the local registry 404, a machine learning model may be trained, tested, and/or evaluated. For example, within local registry 404, a particular user profile may generate or otherwise initiate a particular machine learning model of a particular model type, and configure such a machine learning model in one or more phase(s) using one or more portions of training data, test data, validation data, and/or the like. A particular user profile may access the local registry 404 to continue to train the machine learning model until the machine learning model satisfies particular criteria desired by the user profile, a user associated therewith, and/or satisfies publication criteria defined for publication to the centralized registry 406. In some embodiments, the publication criteria embodies or includes governance criteria defined by an entity responsible for controlling machine learning model storage to the centralized registry 406.

In some embodiments, the local registry 404 embodies or includes one or more third-party workspace(s). The local registry 404 may be executed or otherwise maintained via one or more third-party computing resource(s) embodying the local registry 404. Additionally or alternatively, in some embodiments, the local registry 404 includes or is accessible via at least one first-party workspace, for example embodying a subcomponent of the centralized registry 406. In some embodiments, the local registry 404 includes or otherwise is accessible via a user device that enables performance of the model training, testing, validation, evaluation, and/or other functionality described with respect to local registry 404.

In some embodiments, a particular user profile publishes a machine learning model to a centralized registry 406. In some embodiments a publication process is initiated from the local registry 404 to the centralized registry 406. Upon publication, for example, the machine learning model configured or otherwise trained via the local registry 404 may be transmitted for storage via the centralized registry 406. In some such embodiments, upon initiation of the publication process via the local registry 404, one or more data artifact(s) associated with the training of the local registry 404 are retrieved and/or received by the centralized registry 406, for example via one or more workspace data hook(s). In some embodiments, the centralized registry 406 determines whether to continue publication based on data derived by or indicated in the data artifact(s) (e.g., evaluation data) satisfies particular publication criteria.

As illustrated, the centralized registry 406 includes a metadata repository 408 and a model repository 410. In some embodiments, the model repository 410 embodies one or more database(s), for example local database(s), cloud database(s), and/or any combination thereof. The model repository 410 is specially configured to store any number of data object(s), each embodying a stored machine learning model maintained by the model centralization system. In some embodiments, for example, the model repository 410 is specially configured to store a canonical representation for each machine learning model that successfully completes publication. In some embodiments, the metadata repository 408 embodies one or more database(s), for example local database(s), cloud database(s), and/or any combination thereof. The metadata repository 408 is specially configured to store any number of data object(s) representing metadata, supporting data, additional data, and/or other separate data associated with training, operation, or other characteristics of a machine learning model, the user or user profile that trained or operated the machine learning model, the computing environment(s) utilized to configure the machine learning model, the training data utilized to train the machine learning model, and/or the like. In some embodiments, the data stored in the metadata repository 408 is stored including or associated with a particular identifier that uniquely identifies the particular machine learning model with which such data object(s) stored to the database(s) correspond.

In some embodiments, the centralized registry 406 embodies or includes one or more first-party workspace(s). The centralized registry 406 may be executed or otherwise maintained via one or more first-party workspace(s) embodying the centralized registry 406. Additionally or alternatively, in some embodiments, the centralized registry 406 includes or embodies the at least one first-party workspace, for example embodying a subcomponent of the centralized registry 406. In some embodiments, the centralized registry 406 includes or otherwise is accessible via a user device that enables performance of the functionality associated with the centralized registry 406. In some embodiments, the first-party workspace embodies a compute agnostic project workspace that facilitates initiation of and/or access to any number of third-party workspaces for training and/or otherwise operating a machine learning model. For example, in some embodiments, the first-party workspace of the centralized registry 406 facilitates access to third-party workspaces that, together with the first-party workspace, embody the local registry 404.

As illustrated, for example, the centralized registry 406 may trigger a particular model evaluation process 402 upon initiation of publication via the local registry 404. In some embodiments, the model evaluation process 402 generates, determines, derives, and/or otherwise outputs an approval status indicating whether the machine learning model passes publication and is approved for storing via the centralized registry 406. Additionally or alternatively, in some embodiments, the model evaluation process 402 generates, determines, and/or otherwise derives feedback data indicating whether and/or why the machine learning model failed the model evaluation process 402.

In some embodiments, the model evaluation process 402 includes determining whether evaluation data associated with the machine learning model undergoing publication satisfies particular publication criteria. For example, in some embodiments the centralized registry 406 performs the model evaluation process 402 by comparing evaluation data 416 associated with the machine learning model undergoing publication with particular publication criteria 414. In some embodiments, the publication criteria 414 includes one or more threshold value(s) and/or other check(s) for particular parameter(s) that, if satisfied, indicate that a machine learning model may be undergo publication (e.g., by storing the machine learning model to the centralized registry 406). In some embodiments, the publication criteria 414 is predetermined or otherwise statically maintained by the centralized registry 406. In other embodiments, the centralized registry 406 otherwise determines the publication criteria 414. In one example context, the publication criteria 414 defines particular parameter(s) including a performance parameter, a bias parameter, an interpretability parameter, an explainability parameter, a privacy parameter, and a security parameter. In other contexts, other parameter(s) may be included in publication criteria 414.

As illustrated, the evaluation data 416 includes data value(s) associated with the machine learning model undergoing publication, where such data value(s) correspond to the parameter(s) of the publication criteria 414. For example, in some embodiments, the evaluation data 416 embodies governance criteria defined by a particular entity to indicate whether a particular machine learning model is appropriate for storing and/or publication to a model centralization system. As illustrated, the evaluation data 416 includes performance data 418a, bias data 418b, interpretability data 418c, explainability data 418d, privacy data 418e, and security data 418f. In some embodiments, the centralized registry 406 generates or otherwise determines the evaluation data 416 associated with the machine learning model undergoing publication. For example, in some embodiments, the centralized registry 406 receives data artifact(s) associated with operation of the machine learning model in the local registry 404, for example in real-time during operation of the machine learning model via the local registry 404 or in some embodiments upon triggering of the publication process. In some embodiments, the centralized registry 406 generates the evaluation data 416 based on the data artifact(s) received or otherwise retrieved associated with the machine learning model for publication to determine the evaluation data 416 specific for the machine learning model at the time publication was requested. In a circumstance where the model evaluation process 402 is utilized to determine that the evaluation data 416 satisfies the publication criteria 414, the machine learning model and/or metadata associated therewith may then be stored via the centralized registry 406.

In some embodiments, a particular user profile accesses any such functionality of the centralized registry 406 via a particular user subscription 412. For example, in some embodiments the user subscription 412 embodies or provides access to a particular user profile via a particular user device. In some such embodiments the user may authenticate particular authentication credentials associated with the user subscription 412 to provide access to an authenticated session associated with a particular user profile. During the authenticated session, a user associated with the user profile may perform any of the functionality associated with the centralized registry 406, for example to utilize a local registry 404 to configure a particular model for publication, searching and/or retrieving particular stored machine learning model(s) via the centralized registry 406, and/or deploying a particular deployed instance of a stored machine learning model for use by the user profile corresponding to the user subscription 412. In this regard, different user subscriptions may be accessed to access different deployed instances and/or other data of the centralized registry 406.

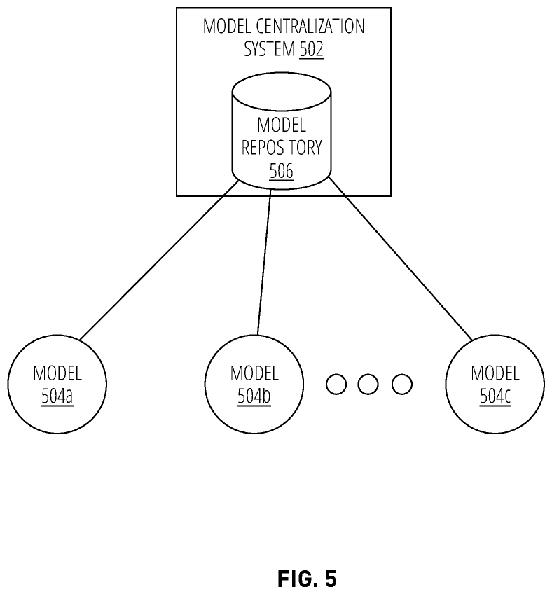

FIG. 5 illustrates a visualization of centralized model storage in a model centralization system in accordance with at least one embodiment of the present disclosure. Specifically, FIG. 5 depicts storage of a plurality of models stored machine learning model 504a-504c maintained by a model centralization system 502. In some embodiments, the model centralization system 502 is embodied by or included as part of the predictive computing entity 102, for example embodying the centralized registry 406 as depicted and described herein.

As illustrated, the model centralization system 502 maintains a model repository 506. The model repository 506 in some embodiments includes one or more databases, repositories, and/or the like, that maintain data record(s) each embodying or identifying a stored machine learning model. In this regard, each machine learning model stored in the model repository 506 may be retrievable as a stored machine learning model via the model centralization system 502. For example, the model repository 506 may be searchable via one or more search query, as described herein, to identify and/or provide one or more search results embodying or identifying the stored machine learning model(s) that are relevant to the search query.

In some embodiments, the model repository 506 is configured to store any number of machine learning models that successfully undergo publication to the model centralization system 502. In some embodiments, the model repository 506 maintains stored machine learning models that underwent publication by any user profile having access to the model centralization system 502. For example, in some embodiments, the stored machine learning model 504a is trained by a first user profile via one or more third-party workspace(s), the machine learning model 504b is trained by a second user profile via one or more other third-party workspace(s), and similarly the machine learning model 504c is trained by a third user profile via one or more other third-party workspace(s). Additionally or alternatively, it will be appreciated that the model repository 506 may store any number of machine learning models trained via the same user profile. For example, in some embodiments the stored machine learning model 504a and the machine learning model 504b represent distinct types of machine learning model, and/or different instances of machine learning models, stored to the model centralization system 502 via the same user profile. In some embodiments, each user profile that configures and/or initiates publication of a stored machine learning model to the model repository 506 accesses the model centralization system 502 via one or more first-party workspace associated therewith.

In some embodiments, the model centralization system 502 similarly stores model metadata associated with each stored machine learning model of the model repository 506. For example, in some such embodiments, the model centralization system 502 similarly maintains a metadata repository including such metadata, model keyword(s), embedded representation(s), data artifact(s), evaluation data, and/or other non-model data associated with each stored machine learning model in the model repository 506. In some embodiments, the metadata repository is embodied as a sub-repository of the model repository 506.

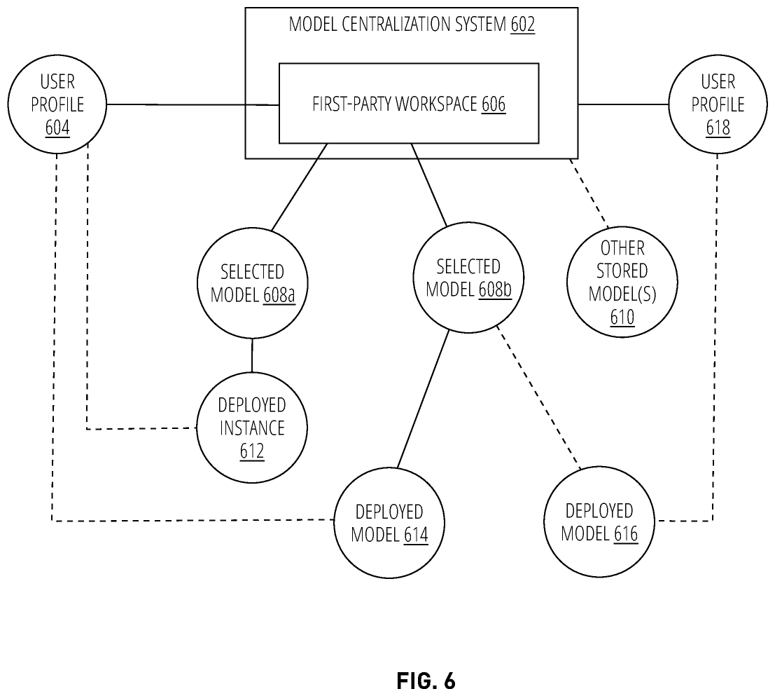

FIG. 6 illustrates a data architecture for model deployment in accordance with at least one embodiment of the present disclosure. Specifically, FIG. 6 depicts model deployment via a model centralization system 602. In some embodiments, the model centralization system 602 is embodied by or as a subsystem of the predictive computing entity 102. Additionally or alternatively, as illustrated, the model centralization system 602 is accessible via any number of user profiles, for example at least the user profile 604 and the user profile 618. Each of the user profile 604 and user profile 618 in some embodiments are associated with a user subscription that enables access to the functionality of the model centralization system 602 at least for model deployed instance.

In some embodiments, the model centralization system 602 maintains at least first-party workspace 606. The first-party workspace 606 enables the user profile 604 to access particular stored machine learning model(s) maintained via the model centralization system 602. For example, in some embodiments, the model centralization system 602 may maintain any number of stored machine learning models, for example each machine learning model that successfully underwent publication for storing via the model centralization system 602. Each machine learning model that underwent publication may be maintained as a stored machine learning model via the model centralization system 602.

In some embodiments, the user profile 604 may select particular machine learning models from the stored machine learning models maintained by the model centralization system 602, where the selected machine learning models are utilized to initiate at least one deployed instance of the selected machine learning model. In some embodiments, a particular stored machine learning model is selected in response to searching of all stored machine learning models by the model centralization system 602. For example, as illustrated, the user profile 604 selects a selected machine learning model 608a and a selected machine learning model 608b from the plurality of stored machine learning models maintained by the model centralization system 602. The model centralization system 602 may maintain any number of other stored machine learning model(s) 610 from which the user profile 604 may search other machine learning model(s) for selecting to deploy yet a new deployed instance.

As illustrated, the user profile 604 is associated with a deployed instance 612 of the selected machine learning model 608a and a deployed instance 614 of the selected machine learning model 608b. In this regard, the user profile 604 may utilize the deployed instance 612 to perform a particular data processing task and the user profile 604 may utilize the deployed instance 614 to perform a particular second data processing task. For example, the deployed instance 612 of the selected machine learning model 608a in some contexts embodies a deployed instance of a specially trained classification model utilized for a classification data processing task, and the deployed instance 614 of the selected machine learning model 608b in some contexts embodies a deployed instance of a specially trained regression model utilized for a regression data processing task.

In some embodiments, each deployed instance of a particular selected model may be executed via one or more deployment workspace(s). For example, in some embodiments the deployment workspace(s) includes at least the first-party workspace 606 and one or more third-party workspace(s) corresponding to the deployed instance(s) of the selected machine learning model(s). For example, in some embodiments the first-party workspace 606 initiates and/or provides access to one or more third-party workspace(s) that facilitate execution of the deployed instance 612, and similarly the first-party workspace 606 initiates and/or provides access to one or more other third-party workspace(s) that facilitate execution of the deployed instance 614. In this regard, the deployed instance(s) may be made accessible via the interaction between the model centralization system 602 and corresponding third-party workspace(s) supporting operation of the deployed instance(s).

The model centralization system 602 similarly provides the other user profiles, such as the user profile 618, access to other deployed instance(s) associated with the user profile 618. For example, as illustrated, the user profile 618 is associated with a deployed instance 616 of the selected machine learning model 608b. In this regard, the user profile 618 may interact with the deployed instance 616 separately from the other deployed instances of the selected machine learning model 608b, for example where the deployed instance 614 and deployed instance 616 may be utilized separately such that the operation of the deployed instance 614 does not impact the operation of the deployed instance 616. Upon deployment, the individual deployed instance 614 and deployed instance 616 may similarly configured by utilizing the baseline configuration of the selected machine learning model 608b as stored by the model centralization system 602.

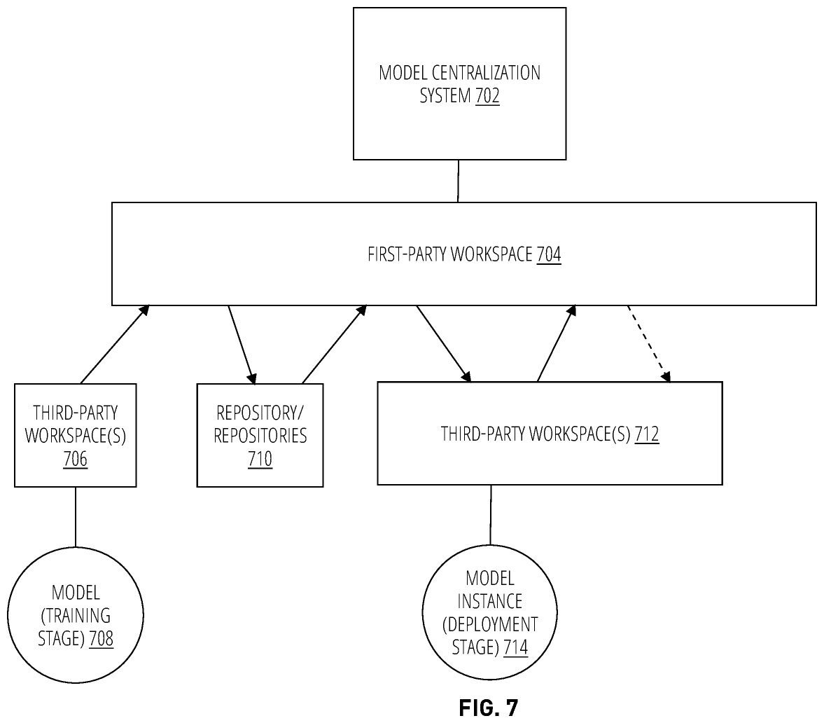

FIG. 7 illustrates a dataflow diagram for a model management process in accordance with at least one embodiment of the present disclosure. Specifically, FIG. 7 illustrates a model management process including publication of a particular machine learning model and deployment of a particular instance of the machine learning model. As illustrated, the model management process is performed at least in part by a model centralization system 702. In some embodiments, the model centralization system 702 is embodied by or included as part of the predictive computing entity 102, as depicted and described herein.

As illustrated, the model centralization system 702 initiates and/or manages a first-party workspace 704. For example, in some embodiments the model centralization system 702 maintains or includes one or more first party resource(s) that executes or otherwise operates the first-party workspace 704. The first-party workspace 704 in some embodiments provides at least one particular user profile access to particular functionality for initiating configuration of a machine learning model, for example machine learning model 708. As illustrated, the machine learning model 708 is configured during a training stage facilitated via the third-party workspace(s) 706. In some embodiments, the third-party workspace(s) 706 are executed via or otherwise operated by one or more third-party computing resource(s), for example of system(s) external from the model centralization system 702. For example, in some embodiments third-party workspace(s) 706 includes or embodies Azure, AWS, or another cloud computing environment specially configured to provide functionality for maintaining training data, generating or otherwise configuring a machine learning model, applying training data to the machine learning model, performing a test and/or validation of the machine learning model, and/or the like. In this regard, a user profile may interact with the first-party workspace 704 to access the third-party workspace(s) 706 to initiate functionality for training the machine learning model 708 and initiating publication of the machine learning model 708 upon completion of the training stage. For example, in some embodiments, the user profile may initiate publication of the machine learning model 708 via the first-party workspace 704 at any point in time, for example via interaction with a particular interface control, where the initiation of publication requests storage of the machine learning model 708, as trained, to the model centralization system 702.

Upon publication, the machine learning model 708 is processed for storage via the model centralization system 702. For example, in some embodiments the machine learning model 708 and/or data representing the machine learning model 708 is transmitted to the model centralization system 702 for processing, for example via the first-party workspace 704. Additionally or alternatively, in some embodiments, data artifact(s) associated with the machine learning model 708 are transmitted to or otherwise received by the model centralization system 702. In some embodiments, the data artifact(s) include metadata, operations data, accuracy data, and/or other data associated with the machine learning model 708. The data artifact(s) may be received via one or more workspace data hook(s) into the third-party workspace(s) 706, where such data artifact(s) are transmitted in real-time during configuration of the machine learning model 708, and/or at the time that publication is initiated.

In some embodiments, the model centralization system 702, for example via the first-party workspace 704, processes the machine learning model 708 and/or data artifact(s) associated therewith to determine whether to publish the machine learning model 708. In a circumstance where the data embodying and/or otherwise associated with the machine learning model 708 satisfies publication criteria, the model centralization system 702 may store the machine learning model 708 and/or associated data in one or more repository/repositories 710. For example, in some embodiments, the model centralization system 702, via the first-party workspace 704, performs a model evaluation process as depicted and described with respect to FIG. 4 to determine whether to store the machine learning model 708 and/or associated data artifact(s) and/or data derived therefrom. In some such embodiments, the first-party workspace 704 generates evaluation data corresponding to the machine learning model 708 based on the data artifact(s) corresponding to the machine learning model 708, and stores the machine learning model 708 to the repository/repositories 710 in a circumstance where the evaluation data satisfies publication criteria maintained or otherwise accessible to the model centralization system 702. In this regard, the model centralization system 702 may maintain the machine learning model 708 as a stored machine learning model in the repository/repositories 710. The repository/repositories 710 may be embodied by hardware, software, firmware, and/or any combination thereof within the model centralization system 702, and/or in some embodiments external to the model centralization system 702 (e.g., one or more cloud or remote repositories).

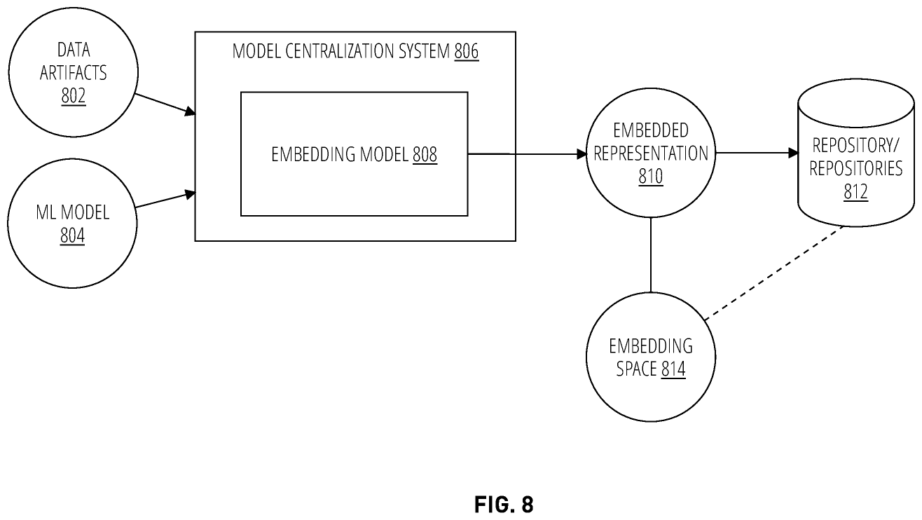

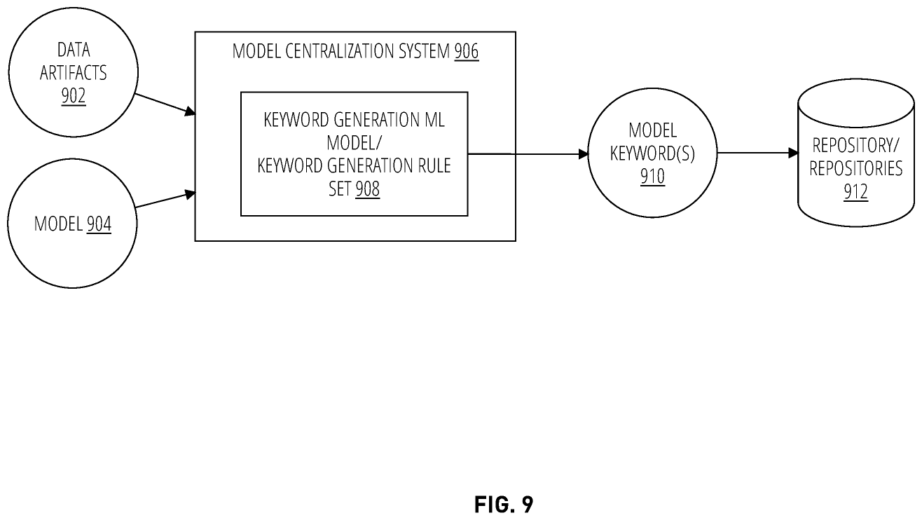

Upon successful publication of a machine learning model, the repository/repositories 710 may be searched and/or otherwise interacted with to select a particular machine learning model for deployment. In some embodiments, a user profile may interact with the first-party workspace 704 to search the various stored machine learning model(s) in the repository/repositories 710, and select a particular stored machine learning model for deployment workspace. The stored machine learning model(s) may be stored by the user profile or by another user profile that stores to the model centralization system 702. In some embodiments, the user profile engages model centralization system 702 as depicted and described with respect to FIGS. 8, 9, and/or 10 to select particular stored machine learning model for deployment.

As illustrated, in some embodiments where the user profile selects a particular stored machine learning model for deployment, the model centralization system 702 initiates a deployed instance of the selected machine learning model stored from the repository/repositories 710. In some embodiments, the deployed instance embodies a separate instance of the stored machine learning model initiated with parameter value(s) corresponding to the stored machine learning model. In this regard, the stored machine learning model selected from the repository/repositories 710 may be utilized as a template for the new deployed instance. As illustrated, the model centralization system 702 is utilized to initiate the machine learning model 714, for example corresponding to the machine learning model 708.

As illustrated, the machine learning model 714 is deployed via particular deployment workspace(s). In some embodiments, the deployment workspace(s) includes at least the first-party workspace 704 utilized to initiate the deployed instance. In some such embodiments, the deployed instance is executed solely via the first-party workspace 704. Additionally or alternatively, in some embodiments, the machine learning model 714 is initiated via at least one third-party workspace, such as the third-party workspace(s) 712. In some embodiments, the model centralization system 702 initiates the third-party workspace(s) 712 via the first-party workspace 704, where the appropriate third-party workspace(s) are initiated based on the particular selected machine learning model for deployment. In this regard, a user profile may interact with the deployed instance of the selected machine learning model, for example embodied by the machine learning model 714, utilizing the first-party workspace 704. The user profile may interact with the first-party workspace 704 to cause execution of particular functionality via the corresponding third-party workspace(s) 712. It will be appreciated that a user profile may initiate any number of deployed instances of stored machine learning model(s)

As the user profile interacts with the machine learning model 714, in some embodiments additional data artifact(s) are received in response to operation of the machine learning model 714 via the third-party workspace(s) 712. In some such embodiments, the model centralization system 702 processes such updated and/or additional data associated with the machine learning model 714 for any of a myriad of purposes. In some embodiments, the model centralization system 702 processes such additional data artifact(s) to monitor updated evaluation data associated with the machine learning model 714, determine whether to terminate access to the machine learning model 714, and/or the like as further described herein.

FIG. 8 illustrates a dataflow diagram for model publication utilizing embedded representations in accordance with at least one embodiment of the present disclosure. Specifically, FIG. 8 depicts publication and storage of a particular machine learning model 804 utilizing embedding processing. In some embodiments, the model publication process as depicted and described is performed by a model centralization system 806, for example embodied by or as part of a predictive computing entity 102.

The model centralization system 806 receives or otherwise identifies machine learning model 804 and corresponding data artifacts 802. In some embodiments, the machine learning model 804 is trained and/or otherwise configured via one or more third-party workspace(s) as depicted and described herein. Additionally or alternatively, in some embodiments, the data artifacts 802 is/are received via workspace data hook(s) that integrate the third-party workspace(s) with at least one corresponding first-party workspace, for example maintained via the model centralization system 806.

The model centralization system 806 processes the data artifacts 802 and the machine learning model 804 utilizing an embedding model 808. In some embodiments, the embedding model 808 includes or embodies one or more machine learning model(s) specially configured to generate an embedded representation, for example the embedded representation 810, corresponding to a particular machine learning model, for example the machine learning model 804. In some embodiments, the embedding model 808 includes a specially configured machine learning model that projects, maps, or otherwise embeds data values of the data artifacts 802 corresponding to the machine learning model 804 into a particular embedding space. In this regard, the data values of the data artifacts 802 are represented in the corresponding embedded representation 810 with reduced dimensionality as learned during training and/or configuration of the embedding model 808. The embedding model 808 may be statically maintained or in other embodiments retrieved by the model centralization system 806.

In some embodiments, the embedded representation 810 corresponds to a particular embedding space, such as the embedding space 814. The embedding space 814 may be learned and/or otherwise established by the embedding model 808 during training. In this regard, a plurality of machine learning model(s) may similarly be embedded within the same embedding space to represent similarities and/or distinctions between such machine learning model(s). For example, in some embodiments a first machine learning model associated with first characteristics (e.g., data values for corresponding data artifacts) is mapped to a first embedded representation at a first location within the embedding space, and similarly a second machine learning model associated with second characteristics is mapped to a second embedded representation at a second location within the embedding space. In a circumstance where the two locations corresponding to the individual embedded representations are closely proximate to one another, such proximity indicates similarity between at least some of the first and second characteristics. Similarly, embedded representations that are associated with different locations far from one another in the embedding space indicate that the machine learning models are associated with dissimilar characteristics.

In some embodiments, the model centralization system 806 stores at least the embedded representation 810 corresponding to the machine learning model 804 in repository/repositories 812. For example, in some embodiments the model centralization system 806 stores the embedding space 814 in the repository/repositories 812 together with all embedded representations mapped to the embedding space 814, such that when the embedded representation 810 is generated the embedded representation 810 is stored in one or more data structure(s) embodying the embedding space 814. Additionally or alternatively, in some embodiments the embedded representation 810 is stored in the repository/repositories 812 as a data record including or otherwise linked to a particular identifier that uniquely identifies the machine learning model 804. In some embodiments, the repository/repositories 812 additionally or alternatively stores the machine learning model 804 itself, the data artifacts 802 associated with the machine learning model 804, and/or the like. Upon storing the embedded representation 810, such embedded representation 810 may be utilized to retrieve the corresponding machine learning model 804 at a subsequent time, for example in response to a search query as depicted and described herein.

FIG. 9 illustrates a dataflow diagram for model publication utilizing model keywords in accordance with at least one embodiment of the present disclosure. Specifically FIG. 9 depicts publication and storage of a particular machine learning model 904 utilizing keyword processing. In some embodiments, the model publication process as depicted and described is performed by a model centralization system 906, for example embodied by or as part of a predictive computing entity 102.

The model centralization system 906 receives or otherwise identifies machine learning model 904 and corresponding data artifacts 902. In some embodiments, the machine learning model 904 is trained and/or otherwise configured via one or more third-party workspace(s) as depicted and described herein. Additionally or alternatively, in some embodiments, the data artifacts 902 is/are received via workspace data hook(s) that integrate the third-party workspace(s) with at least one corresponding first-party workspace, for example maintained via the model centralization system 906.

The model centralization system 906 processes the data artifacts 902 and the machine learning model 904 utilizing a keyword generation model 908. In some embodiments, the keyword generation model 908 includes a machine learning model specially trained to generate model keyword(s) based on data value(s) inputted to the machine learning model. Specifically, for example, the model centralization system 906 generates the model keyword(s) 910 corresponding to the machine learning model 904 based on the inputted data artifacts 902 and/or data of the machine learning model 904 itself. In some such embodiments, by automatically generating model keyword(s) based on data automatically collected and/or gathered associated with training, configuration, and/or operation of the machine learning model, embodiments of the present disclosure assign model keyword(s) that are more accurate and less prone to user-driven error to improve the accuracy of model searching based on such keywords.

In some embodiments, the keyword generation model 908 includes a machine learning model configured for generation of the model keyword(s) 910. In some such embodiments, the machine learning model is specially trained utilizing a supervised learning mechanism (e.g., using training data artifacts marked with label(s) representing the particular model keyword(s) corresponding to the particular data values of the data artifact(s) processed during training) or an unsupervised learning mechanism (e.g., using unlabeled training data).

Additionally or alternatively, in some embodiments, the keyword generation model 908 includes or is embodied by a keyword generation rule set. In some embodiments, the keyword generation rule set includes computer program instructions embodying one or more data-driven determination(s), derivation(s), and/or other formula(s) that generate one or more model keyword(s) from inputted data, such as he data artifacts 902.

In some embodiments, each model keyword of the model keyword(s) 910 includes or embodies a particular text, value, or other data that represents a determined characteristic associated with the machine learning model 904. In some embodiments, for example, the model keyword(s) 910 for the machine learning model 904 indicates characterizations and/or classifications of the machine learning model 904, operation thereof, and/or the like. In some embodiments, the keyword generation model 908 is specially configured to generate model keyword(s) 910 determined most likely to be relevant to a particular user profile during searching of any number of stored machine learning model.

As illustrated, the model centralization system 906 stores at least the model keyword(s) 910 to the repository/repositories 912. The model keyword(s) 910 are stored corresponding to the particular machine learning model 904. For example, in some embodiments, the model centralization system 906 stores the model keyword(s) 910 in one or more data record(s) linked to the machine learning model 904, for example via at least one identifier that uniquely identifies the machine learning model 904. In some embodiments, the repository/repositories 912 additionally or alternatively stores the machine learning model 904 itself, the data artifacts 902 associated with the machine learning model 904, and/or the like. Upon storing the model keyword(s) 910, such model keyword(s) 910 may be utilized to retrieve the corresponding machine learning model 904 at a subsequent time, for example in response to a search query as depicted and described herein.

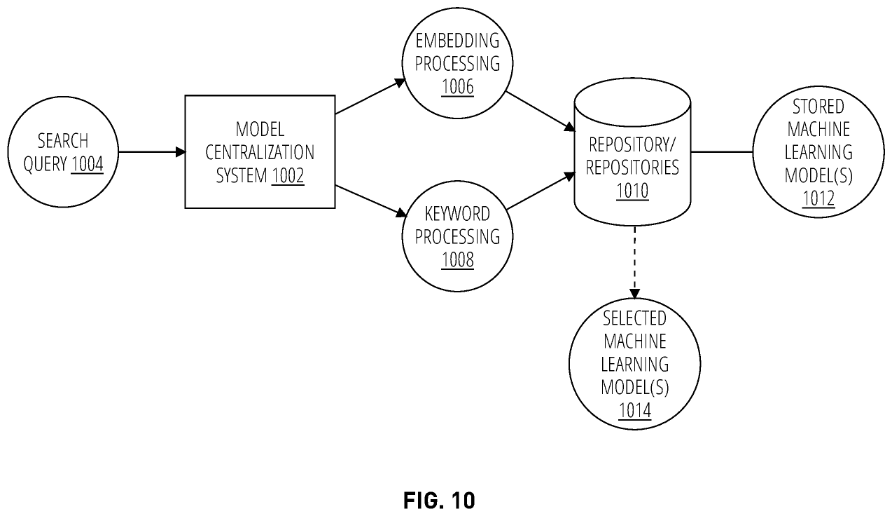

FIG. 10 illustrates a dataflow diagram for model searching in accordance with at least one embodiment of the present disclosure. Specifically, FIG. 10 depicts a data flow for searching stored machine learning model(s). In some embodiments, the stored machine learning models are retrieved to select particular machine learning model(s) from the stored machine learning model(s).

In some embodiments, the data flow begins with receiving a search query 1004. In some embodiments, the search query 1004 is received in response to user engagement via a particular user profile. For example, a user corresponding to a user profile may engage a model centralization system, for example model centralization system 1002, via a corresponding user device, and utilize the user device to input the search query 1004. In some embodiments, the search query 1004 includes free text data inputted by the user via the user device. For example, the user corresponding to the user profile may enter such free text data embodying term(s) representing characteristics for machine learning model(s) that the user desires to retrieve from one or more repositories.

The search query 1004 is received by the model centralization system 1002 to initiate processing of the search query. For example, in some embodiments, the model centralization system 1002 receives the search query 1004 via an API maintained by the model centralization system 1002. In some embodiments, the model centralization system 1002 is transmitted from a corresponding user device via one or more communication network(s).

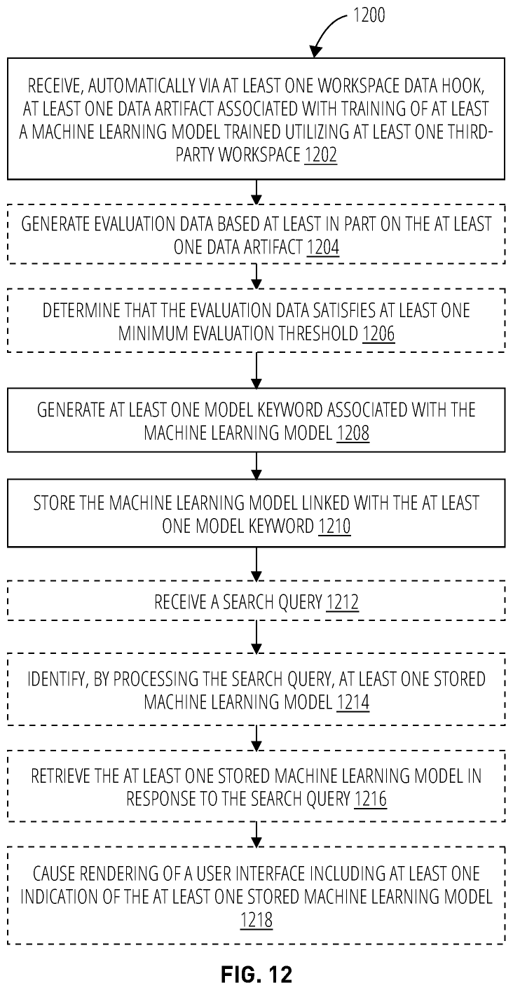

The model centralization system 1002 may process the search query 1004 utilizing any of a myriad of processes. For example, in some embodiments, the model centralization system 1002 processes the search query 1004 utilizing embedding processing 1006. In some embodiments, the model centralization system 1002 executes the embedding processing 1006 by projecting or otherwise mapping the search query 1004 to a particular embedding space, and determining proximate embedded representation(s) that are located close (e.g., within a particular threshold distance) to locations corresponding to such embedded representation(s). For example, the model centralization system 1002 may process the search query 1004 utilizing a specially configured machine learning model, for example configured to generate a corresponding query embedded location by projecting the text of the search query 1004 to a particular embedding space shared with one or more embedded representation(s) of machine learning model(s). In some embodiments, for example, the search query 1004 is utilized to identify N most relevant stored machine learning model(s), where N is any number determined by the model centralization system 1002. An example of operations for an embedding processing 1006 is depicted and described herein with respect to FIG. 12.

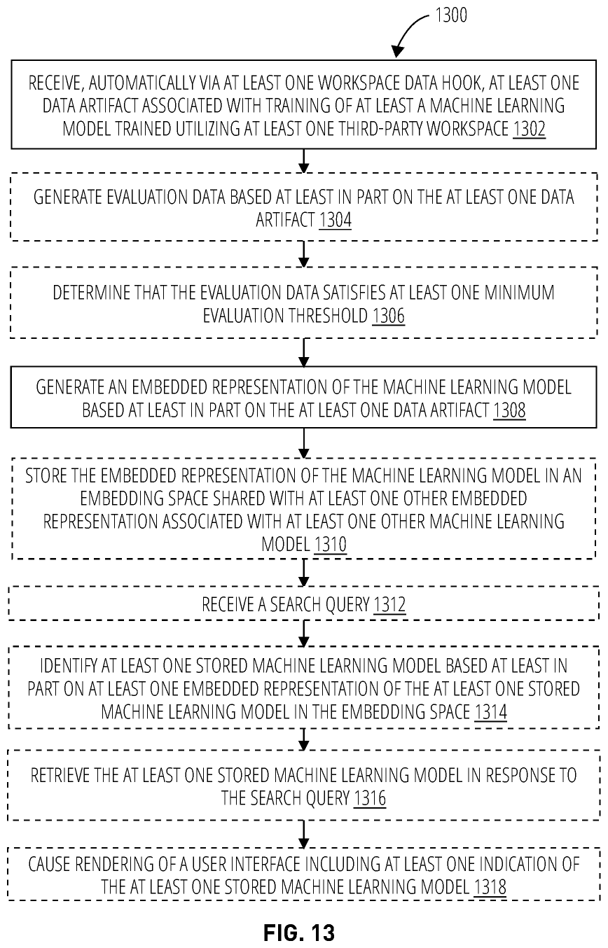

Additionally or alternatively, in some embodiments, the model centralization system 1002 processes the search query 1004 utilizing keyword processing 1008. In some embodiments, the model centralization system 1002 executes the keyword processing 1008 by processing the search query 1004 to determine one or more model keyword(s) determined relevant to the search query 1004. In some embodiments, the keyword processing 1008 includes projecting or otherwise mapping the search query 1004, or a portion thereof, to a keyword embedding space. Using such mapping, the model centralization system 1002 may determine a location within the keyword embedding space corresponding to the search query, or a portion thereof, and determine corresponding model keyword(s) that are determined relevant (e.g., based on proximity as described above) to the location corresponding to the search query or portion thereof. For example, a model keyword determined relevant to the search query 1004 may be determined, and subsequently one or more repositories including stored machine learning model(s) linked with the particular model keyword(s) determined relevant to the search query 1004. In some embodiments, for example, the search query 1004 is utilized to identify N most relevant stored machine learning model(s), where N is any number determined by the model centralization system 1002. An example of operations for a keyword processing 1008 is depicted and described herein with respect to FIG. 13. In some embodiments, the embedding processing 1006 and/or the keyword processing 1008 generates a query embedded location corresponding to the search query 1004 to determine proximate model keyword(s), embedded representation(s) of machine learning model(s), and/or other data proximate to the query embedded location to identify machine learning model(s) relevant to the search query 1004.

As illustrated, the model centralization system 1002 performs the embedding processing 1006 and/or keyword processing 1008 to query from the repository/repositories 1010. For example, the model centralization system 1002 may process the stored machine learning model(s) 1012 in the repository/repositories 1010 to identify a particular subset of the stored machine learning model(s) 1012 for providing in response to the search query 1004. In some embodiments, the user profile that submitted the search query 1004 may receive at least the portion of the stored machine learning model(s) 1012 determined relevant corresponding to the search query 1004 as response to the search query 1004. In some embodiments, the model centralization system 1002 provides at least a portion of the stored machine learning model(s) 1012 for rendering to a corresponding user interface via the user device. Additionally or alternatively, in some embodiments, the user associated with the user profile may provide user engagement to select one or more particular machine learning model(s) from the portion of stored machine learning model(s) 1012 provided in response to the search query 1004. For example, the user may select the selected machine learning model(s) 1014 in particular to initiate a deployed instance of the particular stored machine learning model(s) selected from the stored machine learning model(s) 1012. In this regard, a selected machine learning model in some embodiments represents the machine learning model that a user engaged in response to the search query 1004.

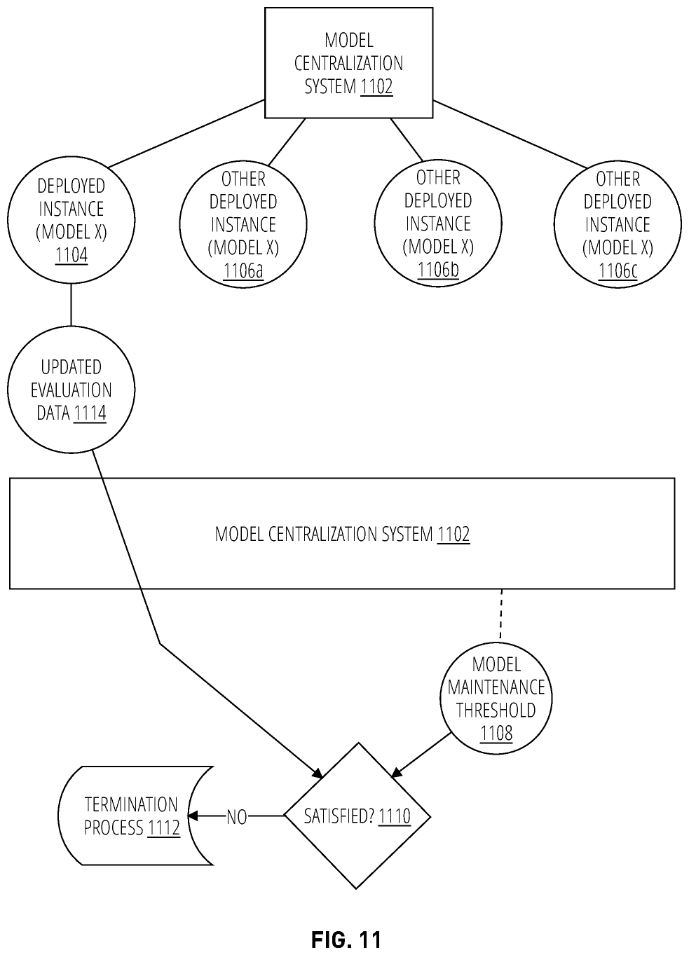

FIG. 11 illustrates a dataflow diagram for a termination process in accordance with at least one embodiment of the present disclosure. Specifically, FIG. 11 depicts an example process for updating data associated with a particular deployed instance of a machine learning model for termination of access to at least the deployed instance. In some embodiments, the dataflow is performed at least in part by a model centralization system 1102, for example embodied by or as part of a predictive computing entity 102.

As illustrated, the model centralization system 1102 facilitates access to a plurality of deployed instances of a particular model, depicted as “model X.” The deployed instances include a first deployed instance 1104 associated with a particular user profile accessing the model centralization system 1102. For example, in some embodiments, the user profile accesses the model centralization system 1102 to update training of the deployed instance 1104 and/or otherwise operate the deployed instance 1104, for example to perform a particular data processing task. Additionally, the model centralization system 1102 maintains any number of other deployed instances of the particular machine learning model X. As depicted, the model centralization system 1102 maintains at least deployed instance 1106a, deployed instance 1106b, and deployed instance 1106c. Each of the other deployed instances may be associated with a different user profile registered with the model centralization system 1102. In this regard, the different user profiles may separately interact with the model centralization system 1102 to independently operate and/or update each of the deployed instance 1104, deployed instance 1106a, deployed instance 1106b, and deployed instance 1106c. In some embodiments, each deployed instance is associated with one or more deployment workspace(s) that facilitate execution and/or operation of functionality associated with execution of the particular deployed instance. For example, in some embodiments the deployment workspace includes at least one first-party workspace maintained by the model centralization system 1102 and/or one or more third-party workspace(s) that facilitates operation of the particular deployed instance.

Upon subsequent operation of the deployed instance 1104, the model centralization system 1102 receives, retrieves, and/or otherwise generates updated evaluation data 1114 corresponding to the deployed instance 1104. In some embodiments, the updated evaluation data 1114 is received from one or more third-party workspace(s) via one more specially configured workspace data hook(s) that enable communication of data associated with operation of the deployed instance 1104 In some embodiments, the updated evaluation data is derived based on such data artifact(s). The model centralization system 1102 may receive data artifacts corresponding to the deployed instance 1104 automatically (dynamically and in real-time during operation of the deployed instance 1104) or in some embodiments receives the data artifacts(s) upon detection of certain data-driven trigger(s) (e.g., in response an initiated request to re-publish (e.g., store updates) associated with the operation of the deployed instance 1104. In some such embodiments, the model centralization system 1102 generates the updated evaluation data 1114 utilizing the updated data artifact(s) received associated with the deployed instance 1104.

The model centralization system 1102 processes the updated evaluation data 1114 associated with the deployed instance 1104 to determine subsequent action(s) to perform. In some embodiments, the model centralization system 1102 processes the updated evaluation data 1114 at least to determine whether to terminate access to deployed instance 1104 for at least a particular user profile corresponding thereto. As depicted, the model centralization system 1102 in some embodiments processes the updated evaluation data 1114 to determine whether the updated evaluation data 1114 satisfies 1110 a corresponding model maintenance threshold 1108. In some embodiments, the model maintenance threshold 1108 is predetermined or otherwise statically available to the model centralization system 1102. In some embodiments, the model centralization system 1102 determines the model maintenance threshold 1108, for example by identifying a particular value corresponding to the deployed instance 1104 and/or the like. In some embodiments, the model centralization system 1102 determines that the updated evaluation data 1114 satisfies the model maintenance threshold 1108 in a circumstance where each of the data values for parameter(s) represented in the updated evaluation data 1114 exceeds (or in other contexts, fails to exceed) a corresponding value of the model maintenance threshold 1108. In some embodiments, the model maintenance threshold 1108 includes or is embodied by at least one drift threshold and/or at least one metric minimum threshold.

In a circumstance where the model centralization system 1102 determines that the updated evaluation data 1114 satisfies 1110 the model maintenance threshold 1108, in some embodiments the deployed instance 1104 is utilized to store updates to a corresponding stored machine learning model. Additionally or alternatively, in some embodiments, no further action is performed in a circumstance where the updated evaluation data 1114 is determined to satisfy 1110 the model maintenance threshold 1108. In one example context, the model maintenance threshold 1108 indicates or includes drift threshold(s) corresponding to drift metric data determined based on the updated evaluation data 1114. In this regard, the model centralization system 1102 may utilize such data to determine whether the deployed instance 1104 is suffering from an unacceptable level of data drift. Additionally or alternatively, in some embodiments, the model centralization system 1102 determines that the updated evaluation data 1114 no longer satisfies particular metric minimum threshold(s) that must be satisfied to enable continued use of the deployed instance 1104. In some embodiments, the metric minimum threshold(s) include one or more data value(s) for particular parameter(s) of publication criteria, and in some embodiments may equal the parameter value(s) for such publication criteria utilized at the time that publication is initiated for a particular machine learning model.

In a circumstance where the model centralization system 1102 determines that the updated evaluation data 1114 does not satisfy the model maintenance threshold 1108, for example because one or more data values of the updated evaluation data 1114 does not satisfy one or more corresponding threshold values of the model maintenance threshold 1108, the model centralization system 1102 initiates a termination process 1112. In some embodiments, the termination process 1112 ceases access to the deployed instance 1104. In some embodiments, the termination process 1112 terminates access of the particular user profile to the deployed instance 1104. Additionally or alternatively, in some embodiments, the termination process 1112 terminates access of each user profile to any deployed instance of the particular machine learning model corresponding to the deployed instance 1104. In this regard, in some embodiments, the model centralization system 1102 terminates access of the user profiles to each of deployed instance 1104, deployed instance 1106a, deployed instance 1106b, and deployed instance 1106c. In some embodiments, the termination process 1112 triggers the model centralization system 1102 to remove permissions or other authentication credentials associated with the deployed instance 1104. Additionally or alternatively, in some embodiments the model centralization system 1102 terminates or otherwise reconfigures access to one or more deployment workspace(s) associated with the deployed instance 1104, and/or the deployed instance 1106a-deployed instance 1106c.

In some embodiments, upon initiation and/or completion of the termination process 1112, the termination process 1112 includes the model centralization system 1102 terminating access to one or more third-party workspace(s) executing the deployed instance of the stored machine learning model and/or particular other deployed instance(s) associated with the stored machine learning model. Additionally or alternatively, in some embodiments, the model centralization system 1102 triggers generation and/or presentation (e.g., by causing rendering to a user interface) of a notification indicating that access has been terminated. Additionally or alternatively still, in some embodiments the notification prompts the user to continue updating the particular deployed instance of the machine learning model via a new workspace, for example such that the user may continue to refine or otherwise update the machine learning model to satisfy requirements for publication.

Having described example systems and apparatuses, data flows, and data architectures in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example, utilizing one or more of the specially configured components thereof.

Although the example processes depict a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted blocks in some embodiments is/are optional in some, or all, embodiments of the disclosure. Optional blocks are depicted with broken (or dashed) lines. Similarly, it should be appreciated that one or more of the operations of each flowchart may be combinable, replaceable, and/or otherwise altered as described herein.

FIG. 12 illustrates a flowchart depicting example operations of a process for maintaining model publication utilizing model keyword(s) in accordance with at least one embodiment of the present disclosure. Specifically, FIG. 12 depicts an example process 1200. The process 1200 embodies an example computer-implemented method. In some embodiments, the process 1200 is embodied by computer program code stored on a non-transitory computer-readable storage medium of a computer program product configured for execution to perform the process as depicted and described. Alternatively or additionally, in some embodiments, the process 1200 is performed by one or more specially configured computing devices, such as the predictive computing entity 102, for example embodying a model centralization system, alone or in communication with one or more other component(s), device(s), system(s), and/or the like. In this regard, in some such embodiments, the predictive computing entity 102 is specially configured by computer-coded instructions (e.g., computer program instructions) stored thereon, for example, in the memory element 106 and/or another component depicted and/or described herein and/or otherwise accessible to the predictive computing entity 102, for performing the operations as depicted and described. In some embodiments, the predictive computing entity 102 is in communication with one or more external apparatus(es), system(s), device(s), and/or the like, to perform one or more of the operations as depicted and described. In some embodiments, the predictive computing entity 102 is in communication with separate component(s) of a network, external network(s), and/or the like, to perform one or more of the operations as depicted and described. For purposes of simplifying the description, the process 1200 is described as performed by and from the perspective of the predictive computing entity 102.

Although the example process 1200 depicts a particular sequence of operations, the sequence may be altered without departing from the scope of the present disclosure. For example, some of the operations depicted may be performed in parallel or in a different sequence that does not materially affect the function of the process 1200. In other examples, different components of an example device or system that implements the process 1200 may perform functions at substantially the same time or in a specific sequence.

According to some examples, the method includes receiving, automatically via at least one workspace data hook, at least one data artifact associated with training of at least a machine learning model trained utilizing at least one third-party workspace at operation 1202. In some embodiments, the data artifact(s) include or otherwise represent data, or characteristics thereof, utilized to train and/or configure the machine learning model. For example, in some embodiments the data artifact(s) include the training data itself, characteristic(s) derived from the training data, data identifying the user profile that performed the training, data characteristics or other parameter values associated with the user profile that performed the training, performance data associated with the machine learning model during training, and/or the like. In some embodiments, the workspace data hook embodies one or more specially configured API(s) that are established and/or maintained via a first-party workspace, and that connect to the at least one third-party workspace associated with the training of at least the machine learning model.

According to some examples, the method includes generating evaluation data based on the at least one data artifact at optional operation 1204. In some embodiments, the evaluation data includes one or more data value(s) representing particular characteristic(s) associated with the training of the machine learning model. For example, in some embodiments, the evaluation data includes data value(s) indicating performance of the machine learning model, bias of the machine learning model, interpretability of the machine learning model, explainability of the machine learning model, privacy preservation of the machine learning model, and/or security of the machine learning model. In some embodiments, each portion of evaluation data representing a particular parameter is generated utilizing a particular data processing algorithm, a distinct, specially-trained machine learning model, a rule set, and/or the like. Additionally or alternatively still, in some embodiments, each portion of evaluation data is generated based on particular portions of the at least one data architecture.

According to some examples, the method includes determining that the evaluation data satisfies at least one minimum evaluation threshold at optional operation 1206. In some embodiments, each data value represented in the evaluation data is compared with a corresponding minimum evaluation threshold of the at least one minimum evaluation threshold. For example, in some embodiments a performance data portion of the evaluation data is compared with a first minimum evaluation threshold representing a metric minimum threshold corresponding to the performance data portion, and a security data portion of the evaluation data is compared with a second minimum evaluation threshold representing a metric minimum threshold corresponding to the security data portion, and the like. In some embodiments, evaluation data satisfies at least one minimum evaluation threshold in a circumstance where a data value of the evaluation data exceeds the at least one minimum evaluation data. In some embodiments, evaluation data satisfies at least one minimum evaluation threshold in a circumstance where a data value of the evaluation data falls below the at least one minimum evaluation threshold.

According to some examples, the method includes generating at least one model keyword associated with the machine learning model at operation 1208. In some embodiments, the at least one model keyword represents particular characteristic(s) associated with the machine learning model, training of the machine learning model, and/or the like. In some embodiments, the at least one model keyword is generated via at least one keyword generation model. For example, in some such embodiments, the data artifact(s), or at least a portion of the data artifact(s), are applied to the keyword generation model to generate the at least one model keyword.

According to some examples, the method includes storing the machine learning model linked with the at least one model keyword at operation 1210. In some embodiments, for example, the machine learning model is stored to at least one data repository configured to store any number of machine learning model(s) as stored machine learning model(s). In some embodiments, each machine learning model is stored as a canonical representation. Additionally or alternatively, in some embodiments, the data record(s) embodying the machine learning model stored to the at least one data repository includes the at least one model keyword corresponding to the machine learning model to link the at least one model keyword with the machine learning model. Additionally or alternatively still, in some embodiments, a second data repository, for example a metadata model, is configured to store the at least one keyword with an identifier or other key that links the data record(s) of the second data repository with corresponding data record(s) embodying or otherwise associated with the machine learning model in the first data repository, for example stored in a model repository.

According to some examples, the method includes receiving a search query at optional operation 1212. The search query may indicate or include particular data for use in retrieving particular stored machine learning model(s) from one or more repositories. In some embodiments, the search query is received from a user device associated with a particular user profile. In some embodiments, the search query includes or is embodied by one or more data value(s) embodying free text.

According to some examples, the method includes identifying, by processing the search query, at least one stored machine learning model at optional operation 1214. In some embodiments, the search query is processed to determine one or more searched model keyword(s) derived from the search query. In some such embodiments, individual term(s) are parsed and extracted from the search query, where each term defines a searched model keyword. Additionally or alternatively, in some embodiments, the search query is projected to a particular embedding space within which the model keyword(s) are projected, where the search query is projected to a particular query embedded location. In this regard, in some embodiments, model keyword(s) associated with the search query are determinable based on a minimized distance or other determination of proximity between the query embedded location corresponding to the search query and individual locations corresponding to each embedded representation of a keyword in the shared embedding space, for example a keyword embedding space. In other embodiments, the search query is processed utilizing any other known search algorithm to determine particular corresponding model keyword(s) based on the search query.

According to some examples, the method includes retrieving the at least one stored machine learning model in response to the search query at optional operation 1216. In some embodiments, the stored machine learning model(s) that are retrieved are associated with or otherwise linked to particular model keyword(s) that match or otherwise are relevant to the inputted search query, for example as described with respect to optional operation 1214. In some embodiments, a top N number of stored machine learning models corresponding to the search query are retrieved, for example that correspond to model keyword9s) best matching the search query, such as based on a minimized proximity to one or more model keyword(s) linked to such stored machine learning model(s).

According to some examples, the method includes causing rendering of a user interface including at least one indication of the at least one stored machine learning model at optional operation 1218. The user interface may be configured to receive user engagement, for example such that a user may select a particular model from the retrieved set of stored machine learning model(s). In some embodiments, the user interface includes the stored machine learning model(s) defined in a particular order, for example based on a determination of which stored machine learning model best matches the search query (e.g., based on best matching, such as by being most proximate to, model keyword(s) associated with a particular stored machine learning model corresponding to the search query). In this regard, the stored machine learning model(s) best matching the search query may be ordered first, with each position in a set or list of the stored machine learning models that were retrieved indicating less relevance to the search query. In some embodiments, the user interface is rendered to a display of the predictive computing entity 102. Additionally or alternatively, in some embodiments, the method causes rendering of the user interface by transmitting particular data embodying the user interface or otherwise utilized to render the user interface to a corresponding user device including a display to which the user interface is rendered. In some embodiments, for example, data embodying or otherwise representing the retrieved at least one stored machine learning model is/are transmitted.

FIG. 13 illustrates a flowchart depicting example operations of a process for maintaining model publication utilizing model embedding in accordance with at least one embodiment of the present disclosure. Specifically, FIG. 13 depicts operations of an example process 1300. Specifically, FIG. 13 depicts an example process 1300. The process 1300 embodies an example computer-implemented method. In some embodiments, the process 1300 is embodied by computer program code stored on a non-transitory computer-readable storage medium of a computer program product configured for execution to perform the process as depicted and described. Alternatively or additionally, in some embodiments, the process 1300 is performed by one or more specially configured computing devices, such as the predictive computing entity 102, for example embodying a model centralization system, alone or in communication with one or more other component(s), device(s), system(s), and/or the like. In this regard, in some such embodiments, the predictive computing entity 102 is specially configured by computer-coded instructions (e.g., computer program instructions) stored thereon, for example, in the memory element 106 and/or another component depicted and/or described herein and/or otherwise accessible to the predictive computing entity 102, for performing the operations as depicted and described. In some embodiments, the predictive computing entity 102 is in communication with one or more external apparatus(es), system(s), device(s), and/or the like, to perform one or more of the operations as depicted and described. In some embodiments, the predictive computing entity 102 is in communication with separate component(s) of a network, external network(s), and/or the like, to perform one or more of the operations(s) as depicted and described. For purposes of simplifying the description, the process 1300 is described as performed by and from the perspective of the predictive computing entity 102.

Although the example process 1300 depicts a particular sequence of operations, the sequence may be altered without departing from the scope of the present disclosure. For example, some of the operations depicted may be performed in parallel or in a different sequence that does not materially affect the function of the process 1300. In other examples, different components of an example device or system that implements the process 1300 may perform functions at substantially the same time or in a specific sequence.

According to some examples, the method includes receiving, automatically via at least one workspace data hook, at least one data artifact associated with training of at least a machine learning model trained utilizing at least one third-party workspace at operation 1302. In some embodiments, the data artifact(s) include or otherwise represent data, or characteristics thereof, utilized to train and/or configure the machine learning model. For example, in some embodiments the data artifact(s) include the training data itself, characteristic(s) derived from the training data, data identifying the user profile that performed the training, data characteristics or other parameter values associated with the user profile that performed the training, performance data associated with the machine learning model during training, and/or the like. In some embodiments, the workspace data hook embodies one or more specially configured API(s) that are established and/or maintained via a first-party workspace, and that connect to the at least one third-party workspace associated with the training of at least the machine learning model.

According to some examples, the method includes generating evaluation data based on the at least one data artifact at optional operation 1304. In some embodiments, the evaluation data includes one or more data value(s) representing particular characteristic(s) associated with the training of the machine learning model. For example, in some embodiments, the evaluation data includes data value(s) indicating performance of the machine learning model, bias of the machine learning model, interpretability of the machine learning model, explainability of the machine learning model, privacy preservation of the machine learning model, and/or security of the machine learning model. In some embodiments, each portion of evaluation data representing a particular parameter is generated utilizing a particular data processing algorithm, a distinct, specially-trained machine learning model, a rule set, and/or the like. Additionally or alternatively still, in some embodiments, each portion of evaluation data is generated based on particular portions of the at least one data architecture.

According to some examples, the method includes determining that the evaluation data satisfies at least one minimum evaluation threshold at optional operation 1306. In some embodiments, each data value represented in the evaluation data is compared with a corresponding minimum evaluation threshold of the at least one minimum evaluation threshold. For example, in some embodiments a performance data portion of the evaluation data is compared with a first minimum evaluation threshold representing a metric minimum threshold corresponding to the performance data portion, and a security data portion of the evaluation data is compared with a second minimum evaluation threshold representing a metric minimum threshold corresponding to the security data portion, and the like. In some embodiments, evaluation data satisfies at least one minimum evaluation threshold in a circumstance where a data value of the evaluation data exceeds the at least one minimum evaluation data. In some embodiments, evaluation data satisfies at least one minimum evaluation threshold in a circumstance where a data value of the evaluation data falls below the at least one minimum evaluation threshold.

According to some examples, the method includes generating an embedded representation of the machine learning model based on the at least one data artifact at operation 1308. In some embodiments, the embedded representation embodies a mapping or projection of the machine learning model into a particular embedding space. Such a representation is generated based on the characteristic(s) associated with operation, training, and/or other configuration of the machine learning model as represented by the at least one data artifact.

In some embodiments, at least one specially trained embedding model generates the embedded representation. In some embodiments, the embedding model comprises at least one machine learning model specially trained to embed data applied to the at least one machine learning model to a particular reduced dimensionality. For example, in some embodiments, the embedding model comprises a specially trained autoencoder model, clustering model, and/or the like that projects a particular inputted vector of data to a lower dimensionality vector (e.g., a two-dimensional vector embodying a particular embedding space). In some embodiments, the at least one data artifact associated with the machine learning model is applied to the specially configured embedding model as input data to cause the embedding model to generate the embedded representation corresponding to the machine learning model from such inputted data artifact(s).

In some embodiments, the embedded representation of the machine learning model is stored to at least one repository. For example, in some embodiments a model repository or corresponding metadata repository, for example where the repository maintains or embodies the embedding space within which all embedded representation(s) are projected. Additionally or alternatively, in some embodiments the method includes storing the embedded representation of the machine learning model in an embedding space shared with at least one other embedded representation associated with at least one other machine learning model at optional operation 1310. For example, some embodiments generate the at least one other embedded representation in the same manner as described with respect to operations 1302-1308 for any number of other machine learning model(s). Such embedded representations may be stored within the same maintained embedding space.

According to some examples, the method includes receiving a search query at optional operation 1312. The search query may indicate or include particular data for use in retrieving particular stored machine learning model(s) from one or more repositories. In some embodiments, the search query is received from a user device associated with a particular user profile. In some embodiments, the search query includes or is embodied by one or more data value(s) embodying free text.

According to some examples, the method includes identifying at least one stored machine learning model based on at least one embedded representation of the at least one stored machine learning model in the embedding space at optional operation 1314. In some embodiments, the search query is applied to a query embedding model that generates a corresponding query embedded location. In some embodiments, the query embedded location represents a particular location corresponding to particular vector data values in the embedding space based on the search query. In this regard, in some embodiments, the query embedded location is usable to determine which stored machine learning model(s) correspond to embedded representation(s) that are similar to the query embedded location for the search query. In some embodiments, a stored machine learning model is determined proximate to the query embedded location in a circumstance where the embedded representation corresponding to the stored machine learning model is proximate to the query embedded location, for example within a particular distance threshold from the query embedded location. Some embodiments determine a distance between the embedded representation and the query embedded location, and determine whether the distance falls below a particular distance threshold to indicate that the embedded representation is proximate and thus corresponds to a relevant stored machine learning model for the search query received.

According to some examples, the method includes retrieving the at least one stored machine learning model in response to the search query at optional operation 1316. In some embodiments, the at least one stored machine learning model is retrieved by retrieving data associated with all stored machine learning model(s) identified at optional operation 1314, In this regard, data embodying the at least one stored machine learning model and/or identifying the at least one stored machine learning model may be retrieved from one or more repository based on determining that the stored machine learning model is relevant to the search query, for example by determining that an embedded representation corresponding to the stored machine learning model is proximate to the query embedded location described above.

According to some examples, the method includes causing rendering of a user interface including at least one indication of the at least one stored machine learning model at optional operation 1318. The user interface may be configured to receive user engagement, for example such that a user may select a particular model from the retrieved set of stored machine learning model(s). In some embodiments, the user interface includes the stored machine learning model(s) defined in a particular order, for example based on a determination of which stored machine learning model best matches the search query (e.g., based on proximity of an embedded representation corresponding to the stored machine learning model with a query embedded location corresponding to the search query, or otherwise determined similar to the search query). In this regard, the stored machine learning model(s) best matching the search query may be ordered first, with each subsequent position in a set or list of the stored machine learning models that were retrieved indicating less relevance to the search query (e.g., greater proximity or another relevance determination). In some embodiments, the user interface is rendered to a display of the predictive computing entity 102. Additionally or alternatively, in some embodiments, the method causes rendering of the user interface by transmitting particular data embodying the user interface or otherwise utilized to render the user interface to a corresponding user device including a display to which the user interface is rendered. In some embodiments, for example, data embodying or otherwise representing the retrieved at least one stored machine learning model is/are transmitted.

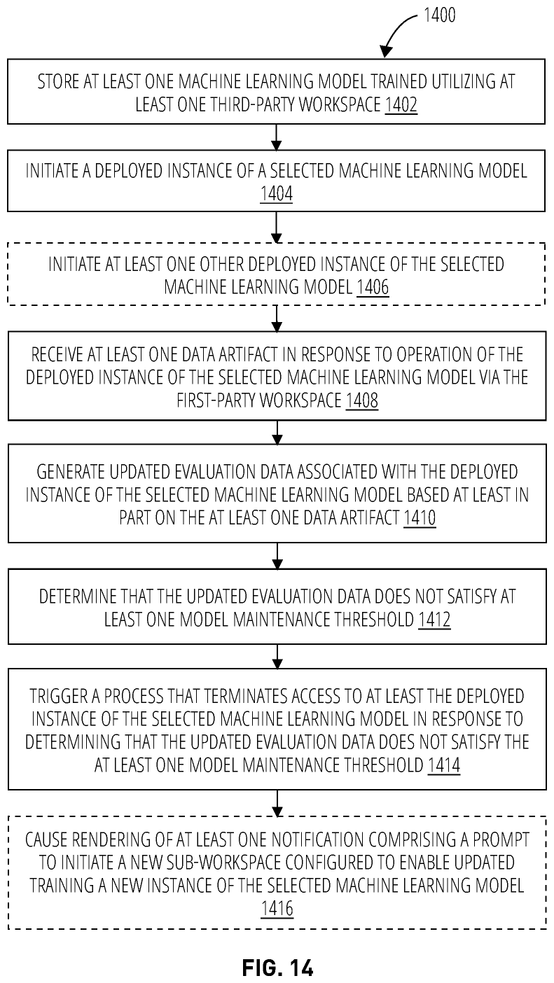

FIG. 14 illustrates a flowchart depicting example operations of a process for model access maintenance in accordance with at least one embodiment of the present disclosure. Specifically, FIG. 14 depicts operations of an example process 1400. In some embodiments, the process 1400 embodies a standalone process. In some embodiments, the process 1400 embodies a sub-process of another process, for example as a sub-process of utilizing a model storage maintained in a particular manner. In this regard, in some embodiments the process 1400 embodies a sub-process of the process 1200 and/or process 1300. In some embodiments, the process 1400 is embodied by computer program code stored on a non-transitory computer-readable storage medium of a computer program product configured for execution to perform the process as depicted and described. Alternatively or additionally, in some embodiments, the process 1400 is performed by one or more specially configured computing devices, such as the apparatus 200 alone or in communication with one or more other component(s), device(s), system(s), and/or the like. In this regard, in some such embodiments, the predictive computing entity 102 is specially configured by computer-coded instructions (e.g., computer program instructions) stored thereon, for example, in the memory element 106 and/or another component depicted and/or described herein and/or otherwise accessible to the predictive computing entity 102, for performing the operations as depicted and described. In some embodiments, the predictive computing entity 102 is in communication with one or more external apparatus(es), system(s), device(s), and/or the like, to perform one or more of the operations as depicted and described. In some embodiments, the predictive computing entity 102 is in communication with separate component(s) of a network, external network(s), and/or the like, to perform one or more of the operations(s) as depicted and described. For purposes of simplifying the description, the process 1400 is described as performed by and from the perspective of the predictive computing entity 102.

Although the example process 1400 depicts a particular sequence of operations, the sequence may be altered without departing from the scope of the present disclosure. For example, some of the operations depicted may be performed in parallel or in a different sequence that does not materially affect the function of the process 1400. In other examples, different components of an example device or system that implements the process 1400 may perform functions at substantially the same time or in a specific sequence.

According to some examples, the method includes storing at least one machine learning model trained utilizing at least one third-party workspace at operation 1402. In some embodiments, the at least one machine learning model are stored to at least one repository, or particular data representations embodying the at least one machine learning model are stored to the at least one repository. Additionally or alternatively, in some embodiments, each of the at least one machine learning model is stored embodied by or together with at least one embedded representation corresponding to the particular machine learning model. Additionally or alternatively, in some embodiments, the at least one machine learning model is stored together with associated metadata, model keyword(s), and/or related data embodying or utilized to search, identify, retrieve, and/or otherwise utilize the machine learning model.

According to some examples, the method includes initiating a deployed instance of a selected machine learning model at operation 1404. In some embodiments, the deployed instance of a selected machine learning model corresponds to a particular user profile, such that a user authenticated associated with the user profile is provided access to the deployed instance. Additionally or alternatively, in some embodiments, particular data indicating or otherwise identifying a particular stored machine learning model is received associated with the user profile, where such data indicates a request to initiate the deployed instance of the selected stored machine learning model. In this regard, the deployed instance of the selected machine learning model in some embodiments comprises an individual or separate portion of computing resource(s), data object(s), and/or the like that are usable, updateable (e.g., via subsequent training) and/or otherwise separately usable by the particular user profile, where the stored version of the selected machine learning model is utilized as the template utilized to initiate the deployed instance of such a machine learning model. It should be appreciated that different user profiles may be associated with different deployed instances of the same stored machine learning model.

In some embodiments, a deployed instance of a selected machine learning model is instantiated via one or more particular workspace(s). For example, in some embodiments, the deployed instance of a selected machine learning model is instantiated in a manner made accessible via at least one first-party workspace associated with the user profile that selected the particular selected machine learning model for deploying. In this regard, the first-party workspace in some embodiments is communicable with or otherwise provides access to one or more particular third-party workspace(s) that embody or otherwise facilitate access to functionality of the deployed instance of the selected machine learning model.

According to some examples, the method includes initiating at least one other deployed instance of the selected machine learning model at optional operation 1406. In this regard, it will be appreciated that other user profile(s), for example, may be associated with different, other deployed instances of the selected machine learning model. In some such embodiments, each of the deployed instances of the selected machine learning model may be accessible via a different first-party workspace, for example associated with different user profiles corresponding to the different deployed instances. Additionally or alternatively, in some embodiments, a user profile may be associated with multiple deployed instances of the same selected machine learning model, where each deployed instance is updateable and/or otherwise usable independently from the other deployed instances of that selected machine learning model. Such deployed instances in some embodiments are maintained via the same first-party workspaces, or in some embodiments are associated with separate first-party workspaces. Similarly, in some embodiments such deployed instances are associated with different third-party workspaces instantiated for each deployed instance.

According to some examples, the method includes receiving at least one data artifact in response to operation of the deployed instance of the selected machine learning model via the first-party workspace at operation 1408. In some embodiments, the first-party workspace generates, identifies, and/or retrieves the at least one data artifact in response to the operation of the deployed instance. Additionally or alternatively, in some embodiments, the first-party workspace receives at least one data artifact via at least one workspace data hook. The workspace data hook in some embodiments enables retrieval of the at least one data artifact from at least one third-party workspace associated with operation of the deployed instance of the selected machine learning model. In some embodiments, the workspace data hook(s) are configured to retrieve and/or otherwise receive such data artifact(s) automatically as operations of the deployed instance occur, and/or in response to particular trigger events (e.g., reconfiguration or updated training of the deployed instance, execution of a validation step in a machine learning task executed via the deployed instance, and/or the like) associated with operation of the deployed instance of the selected machine learning model.

According to some examples, the method includes generating updated evaluation data associated with the deployed instance of the selected machine learning model based on the at least one data artifact at operation 1410. In some embodiments, the updated evaluation data includes one or more updated data value(s) for publication criteria utilized to maintain storage and/or access to the selected machine learning model, for example representing particular characteristic(s) associated with the training of the machine learning model. For example, in some embodiments, the updated evaluation data includes updated data value(s) indicating performance of the machine learning model, bias of the machine learning model, interpretability of the machine learning model, explainability of the machine learning model, privacy preservation of the machine learning model, and/or security of the machine learning model. In some embodiments, each portion of the updated evaluation data representing a particular parameter is generated utilizing a particular data processing algorithm, a distinct specially-trained machine learning model, a rule set, and/or the like. Additionally or alternatively still, in some embodiments, each portion of updated evaluation data is generated based on particular portions of the at least one data architecture.

According to some examples, the method includes determining that the updated evaluation data does not satisfy at least one model maintenance threshold at operation 1412. In some embodiments, each data value represented in the updated evaluation data is compared with a corresponding minimum evaluation threshold of the at least one model maintenance threshold. For example, in some embodiments a performance data portion of the updated evaluation data is compared with a first minimum evaluation threshold representing a metric minimum threshold corresponding to the performance data portion, and a security data portion of the updated evaluation data is compared with a second minimum evaluation threshold representing a metric minimum threshold corresponding to the security data portion, and the like. In some embodiments, updated evaluation data satisfies at least one minimum evaluation threshold in a circumstance where a data value of the updated evaluation data exceeds the at least one minimum evaluation data. In some embodiments, updated evaluation data satisfies at least one minimum evaluation threshold in a circumstance where a data value of the evaluation data falls below the at least one minimum evaluation threshold.

In some embodiments, some or all of the updated evaluation data is utilized to determine drift metric data. In some embodiments, for example, the drift metric data embodies a drift between (I) a data value for particular publication criteria at the time that the selected machine learning model was published as represented by evaluation data initially received at the time of publication of the selected machine learning model, and (II) a data value corresponding to the particular publication criteria in the updated evaluation data. For example, in some embodiments the drift metric data is determined utilizing one or more data drift algorithm(s) that determine the difference between data values of the evaluation data and updated evaluation data, and/or otherwise determine a difference in the probabilistic distributions represented by the portions of evaluation data and/or updated evaluation data. In some embodiments, the drift metric data is compared with at least one drift threshold to determine whether the drift metric data indicates an unacceptable data drift. For example, in some embodiments the drift metric data indicates an unacceptable data drift in a circumstance where the drift metric data satisfies a drift threshold of the at least one model maintenance threshold. In some such embodiments, the updated evaluation data does not satisfy the at least one model maintenance threshold in a circumstance where the drift metric data derived from the updated evaluation data is determined to indicate an unacceptable data drift.

According to some examples, the method includes triggering a process that terminates access to at least the deployed instance of the selected machine learning model at operation 1414. In some embodiments, the access to the deployed instance is terminated in response to determining that the updated evaluation data does not satisfy the at least one model maintenance threshold, for example as described with respect to operation 1412. In this regard, the termination of access may prevent a particular user, for example associated with a particular user profile, from utilizing the deployed instance of the selected machine learning model to perform a data processing task. In some embodiments, the process includes terminating access of a first-party workspace associated with the user profile to the one or more third-party workspace(s) that support functionality of the deployed instance of the selected machine learning model. Additionally or alternatively, in some embodiments, the process includes terminating access of a user profile to particular first-party workspace(s) that are associated with or support the deployed instance of the selected machine learning model.

In some embodiments, access is terminated to a single deployed instance. For example, in a circumstance where the updated evaluation data for a particular deployed instance of a selected machine learning model is determined to not satisfy the at least one model maintenance threshold, in some embodiments access to only that deployed instance is termination. In some other embodiments, in a circumstance where the updated evaluation data for a particular deployed instance of a selected machine learning model is determined to not satisfy the at least one model maintenance threshold, access to all deployed instances of that selected machine learning model are terminated. In this regard, the determination of a single deployed instance no longer satisfying the at least one model maintenance threshold may affect solely that deployed instance of the selected machine learning model or a plurality of deployed instances of the selected machine learning model.

According to some examples, the method includes causing rendering of at least one notification comprising a prompt to initiate a new sub-workspace configured to enable updated training a new instance of the selected machine learning model at optional operation 1416. In some embodiments, the notification is rendered as a user interface to a display of the predictive computing entity 102. Additionally or alternatively, in some embodiments, the method causes rendering of the notification as a user interface by transmitting particular data embodying the user interface or otherwise utilized to render the user interface to a corresponding user device including a display to which the user interface is rendered. In some embodiments, for example, data embodying or otherwise identifying the deployed instance, the selected machine learning model, and/or indicating that access was terminated is transmitted.

In some embodiments, one notification is generated and caused to be rendered in response to the termination of access. In some embodiments, a plurality of notifications is generated and caused to be rendered in response to the termination of access. For example, some embodiments cause rendering of a prompt for each user profile of a plurality of user profiles, or a single user profile, for which access was terminated. In some embodiments, each notification includes data indicating or requesting a user associated with a user profile to initiate a new sub-workspace configured to enable updated training of a new instance the selected machine learning model and publication of the new instance upon completion of the updated training. In this regard, in some embodiments the notification is configured to receive user engagement that initiates at least one new workspace utilized to configure a new machine learning model, which can subsequently undergo publication for subsequent deployment via the user profile or one or more other user profile(s).

### VI. CONCLUSION

Embodiments of the present disclosure can be implemented in various ways, including as computer program products that comprise articles of manufacture. Such computer program products can include one or more software components including, for example, software objects, methods, data structures, or the like. A software component can be coded in any of a variety of programming languages. An illustrative programming language can be a lower-level programming language such as an assembly language associated with a particular hardware architecture and/or operating system platform. A software component comprising assembly language instructions can require conversion into executable machine code by an assembler prior to execution by the hardware architecture and/or platform. Another example programming language can be a higher-level programming language that can be portable across multiple architectures. A software component comprising higher-level programming language instructions can require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages can be executed directly by an operating system or other software component without having to be first transformed into another form. A software component can be stored as a file or other data storage construct. Software components of a similar type or functionally related can be stored together such as, for example, in a particular directory, folder, or library. Software components can be static (e.g., pre-established, or fixed) or dynamic (e.g., created or modified at the time of execution).

A computer program product can include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium can include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium can also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium can also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium can also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium can include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media can be substituted for or used in addition to the computer-readable storage media described above.

As should be appreciated, various embodiments of the present disclosure can also be implemented as methods, apparatus, systems, computing devices, computing entities, and/or the like. As such, embodiments of the present disclosure can take the form of an apparatus, system, computing device, computing entity, and/or the like executing instructions stored on a non-transitory computer-readable storage medium to perform certain steps or operations. Thus, embodiments of the present disclosure can also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations can be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a non-transitory computer-readable storage medium for execution. For example, retrieval, loading, and execution of code can be performed sequentially such that one instruction is retrieved, loaded, and executed at a time. In some exemplary embodiments, retrieval, loading, and/or execution can be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

### VII. EXAMPLES

Example 1. A computer-implemented method including: receiving, by at least one processor and automatically via at least one workspace data hook, at least one data artifact associated with training of at least a machine learning model trained utilizing at least one third-party workspace, where the at least one workspace data hook integrates with the at least one third-party workspace; generating, by the at least one processor, at least one model keyword associated with the machine learning model, where the at least one model keyword is generated based on the at least one data artifact associated with the machine learning model; and storing, by the at least one processor, the machine learning model linked with the at least one model keyword.

Example 2. The computer-implemented method of any of the preceding examples, further including receiving a search query; identifying, by processing the search query, at least one stored machine learning model, where the at least one stored machine learning model includes the machine learning model retrieved based on the at least one model keyword linked with the machine learning model; and retrieving the at least one stored machine learning model in response to the search query.

Example 3. The computer-implemented method of any of the preceding examples, further including causing rendering of a user interface including at least one indication of the at least one stored machine learning model.

Example 4. The computer-implemented method of any of the preceding examples, where identifying the at least one stored machine learning model includes mapping at least a portion of the search query to a particular location in a keyword embedding space; and determining that the at least one model keyword is relevant to the search query based on a distance between the particular location and at least one second location in the keyword embedding space, where the at least one second location is associated with the at least one model keyword.

Example 5. The computer-implemented method of any of the preceding examples, where the at least one stored machine learning model includes a plurality of machine learning models, the plurality of machine learning models including at least a first machine learning model trained via a first third-party workspace and a second machine learning model trained via a second third-party workspace.

Example 6. The computer-implemented method of any of the preceding examples, where the at least one workspace data hook dynamically retrieves the at least one data artifact via the at least one third-party workspace in real-time during training of the machine learning model.

Example 7. The computer-implemented method of any of the preceding examples, where the at least one workspace data hook retrieves the at least one data artifact via the at least one third-party workspace upon initiation of publication of the machine learning model to a model centralization system.

Example 8. The computer-implemented method of any of the preceding examples, where the model centralization system maintains a first-party workspace providing access to the at least one third-party workspace.

Example 9. The computer-implemented method of any of the preceding examples, where the at least one third-party workspace includes a plurality of third-party workspaces, each particular third-party workspace of the plurality of third-party workspaces integrated via the at least one workspace data hook.

Example 10. The computer-implemented method of any of the preceding examples, where the at least one data artifact includes data representing a model type corresponding to the machine learning model, a training data set utilized to train the machine learning model, data representing at least one characteristic of the training data set utilized to train the machine learning model, metadata associated with a user profile utilized to train the machine learning model, data representing an accuracy of the machine learning model, or any combination thereof.

Example 11. The computer-implemented method of any of the preceding examples, further including generating evaluation data corresponding to the machine learning model based on the at least one data artifact; determining that the evaluation data satisfies at least one minimum evaluation threshold; and storing the machine learning model in response to determining that the evaluation data satisfies the at least one minimum evaluation threshold.

Example 12. The computer-implemented method of any of the preceding examples, where generating the at least one model keyword associated with the machine learning model includes applying the at least one data artifact to a keyword generation model trained to output the at least one model keyword based on the at least one data artifact.

Example 13. The computer-implemented method of any of the preceding examples, where generating the at least one model keyword associated with the machine learning model includes applying the at least one data artifact to a keyword generation rule set that defines the at least one model keyword based on the at least one data artifact.

Example 14. A computer-implemented method including receiving, by at least one processor and automatically via at least one workspace data hook, at least one data artifact associated with training of at least a machine learning model trained utilizing at least one third-party workspace, where the at least one workspace data hook integrates with the at least one third-party workspace; generating, by the at least one processor, an embedded representation of the machine learning model based on the at least one data artifact; and storing, by the at least one processor, the embedded representation of the machine learning model in an embedding space shared with at least one other embedded representation associated with at least one other machine learning model.

Example 15. The computer-implemented method of any of the preceding examples, further including receiving a search query; identifying, by processing the search query, at least one stored machine learning model, where the at least one stored machine learning model is retrieved based on at least one embedded representation of the at least one stored machine learning model in the embedding space; and retrieving the at least one stored machine learning model in response to the search query.

Example 16. The computer-implemented method of any of the preceding examples, further including causing rendering of a user interface comprising at least one indication of the at least one stored machine learning model.

Example 17. The computer-implemented method of any of the preceding examples, where identifying the at least one stored machine learning model includes generating a query embedded location by applying the search query to a query embedding model; and determining the at least one embedded representation of the at least one stored machine learning model is proximate to the query embedded location.

Example 18. The computer-implemented method of any of the preceding examples, where the at least one stored machine learning model comprises a plurality of machine learning models, the plurality of machine learning models comprising at least a first machine learning model trained via a first third-party workspace and a second machine learning model trained via a second third-party workspace.

Example 19. The computer-implemented method of any of the preceding examples, where the search query comprises free text search data that is parseable to map to the embedding space.

Example 20. The computer-implemented method of any of the preceding examples, where the at least one workspace data hook dynamically retrieves the at least one data artifact via the at least one third-party workspace in real-time during training of the machine learning model.

Example 21. The computer-implemented method of any of the preceding examples, where the at least one workspace data hook retrieves the at least one data artifact via the at least one third-party workspace upon initiation of publication of the machine learning model to a model centralization system.

Example 22. The computer-implemented method of any of the preceding examples, where the model centralization system maintains a first-party workspace providing access to the at least one third-party workspace.

Example 23. The computer-implemented method of any of the preceding examples, where generating the embedded representation of the machine learning model based on the at least one data artifact includes applying at least a portion of the at least one data artifact to a clustering model, where the clustering model is specially configured to generate N different clusters of machine learning models defined within the embedding space, and where the machine learning model is assigned to a particular cluster based on the at least one data artifact.

Example 24. The computer-implemented method of any of the preceding examples, where generating the embedded representation of the machine learning model based on the at least one data artifact including applying at least a portion of the at least one data artifact to an embedding model, where the embedding model is specially configured to map an embedded representation of the machine learning model to a particular location in the embedding space based on the portion of the at least one data artifact.

Example 25. A computer-implemented method including storing, by at least one processor, at least one machine learning model trained utilizing at least one third-party workspace; initiating, by the at least one processor, a deployed instance of a selected machine learning model, where the deployed instance of the selected machine learning model is operable via a first-party workspace; receiving, by the at least one processor, at least one data artifact in response to operation of the deployed instance of the selected machine learning model via the first-party workspace; generating, by the at least one processor, updated evaluation data associated with the deployed instance of the selected machine learning model based on the at least one data artifact; determining, by the at least one processor, that the updated evaluation data does not satisfy at least one model maintenance threshold; and triggering, via the at least one processor, a process that terminates access to at least the deployed instance of the selected machine learning model in response to determining that the updated evaluation data does not satisfy the at least one model maintenance threshold.

Example 26. The computer-implemented method of any of the preceding examples, further including receiving user engagement indicating the selected machine learning model from the at least one stored machine learning model in response to a search query executed that results in retrieval of the at least one machine learning model.

Example 27. The computer-implemented method of any of the preceding examples, where initiating the deployed instance of the selected machine learning model includes initiating a deployment workspace that provides access to the deployed instance of the selected machine learning model, where the deployment workspace is configured to enable use or further training of the selected machine learning model; and configuring the deployment workspace to be accessible via the first-party workspace.

Example 28. The computer-implemented method of any of the preceding examples, where the deployment workspace comprises a sub-workspace of the first-party workspace or at least one additional third-party workspace.

Example 29. The computer-implemented method of any of the preceding examples, where the deployed instance of the selected machine learning model comprises a first deployed instance operable by at least a first user profile, and where the computer-implemented method further includes initiating, by the at least one processor, a second deployed instance of the selected machine learning model, where the second deployed instance is operable by at least a second user profile, where the first deployed instance and the second deployed instance are independently operable.

Example 30. The computer-implemented method of any of the preceding examples, where the deployed instance of the selected machine learning model is initiated utilizing at least one third-party workspace accessible via the first-party workspace, and where receiving the at least one data artifact in response to operation of the deployed instance includes receiving the at least one data artifact via at least one workspace data hook that receives the at least one data artifact via the at least one third-party workspace upon updated publication of the deployed instance of the selected machine learning model.

Example 31. The computer-implemented method of any of the preceding examples, where the deployed instance of the selected machine learning model is initiated utilizing at least one third-party workspace accessible via the first-party workspace, and where receiving the at least one data artifact in response to operation of the deployed instance includes receiving the at least one data artifact via at least one workspace data hook that retrieves the at least one data artifact via the at least one third-party workspace in real-time in response to the operation of the deployed instance of the selected machine learning model.

Example 32. The computer-implemented method of any of the preceding examples, where the operation of the deployed instance of the selected machine learning model comprises updated training of the deployed instance of the selected machine learning model or use of the deployed instance of the selected machine learning model for a data processing task.

Example 33. The computer-implemented method of any of the preceding examples, where determining that the updated evaluation data does not satisfy the at least one model maintenance threshold includes determining that at least one metric value of the updated evaluation data does not satisfy a metric minimum threshold defined by a minimum evaluation threshold of the at least one model maintenance threshold.

Example 34. The computer-implemented method of any of the preceding examples, where determining that the updated evaluation data does not satisfy the at least one model maintenance threshold includes determining a drift metric data based on the updated evaluation data; and determining that the drift metric data indicates an unacceptable data drift based on a drift threshold of the at least one model maintenance threshold.

Example 35. The computer-implemented method of any of the preceding examples, where triggering the process that terminates access to at least the deployed instance of the selected machine learning model includes configuring the first-party workspace to make at least the deployed instance of the selected machine learning model inaccessible to a particular user profile associated with the first-party workspace.

Example 36. The computer-implemented method of any of the preceding examples, where triggering the process that terminates access to at least the deployed instance of the selected machine learning model includes configuring at least the first workspace to make a plurality of deployed instances associated with the selected machine learning model inaccessible, where the plurality of deployed instances is associated with a plurality of user profiles.

Example 37. The computer-implemented method of any of the preceding examples, further including causing rendering of a notification comprising a prompt for each user profile of the plurality of user profiles to initiate a new sub-workspace configured to enable updated training of a new instance the selected machine learning model and publication of the new instance upon completion of the updated training.

Example 38. The computer-implemented method of any of the preceding examples, further including causing rendering of a notification comprising a prompt for a user to initiate a new sub-workspace configured to enable updated training of a new instance the selected machine learning model and publication of the new instance upon completion of the updated training.

1. A computer-implemented method comprising:
receiving, by one or more processors and automatically via at least one workspace data hook, at least one data artifact associated with training of at least a machine learning model trained utilizing at least one third-party workspace,
wherein the at least one workspace data hook integrates with the at least one third-party workspace;
generating, by the one or more processors, an embedded representation of the machine learning model based on the at least one data artifact; and
storing, by the one or more processors, the embedded representation of the machine learning model in an embedding space shared with at least one other embedded representation associated with at least one other machine learning model.

2. The computer-implemented method of claim 1, further comprising:
receiving, by the one or more processors, a search query;
identifying, by the one or more processors and based on processing the search query, at least one stored machine learning model, wherein the at least one stored machine learning model is retrieved based on at least one embedded representation of the at least one stored machine learning model in the embedding space; and
retrieving, by the one or more processors, the at least one stored machine learning model in response to the search query.

3. The computer-implemented method of claim 2, further comprising:
causing rendering, by the one or more processors, of a user interface comprising at least one indication of the at least one stored machine learning model.

4. The computer-implemented method of claim 2, wherein identifying the at least one stored machine learning model comprises:
generating, by the one or more processors, a query embedded location by applying the search query to a query embedding model; and
determining, by the one or more processors, the at least one embedded representation of the at least one stored machine learning model is proximate to the query embedded location.

5. The computer-implemented method of claim 2, wherein the at least one stored machine learning model comprises a plurality of machine learning models, the plurality of machine learning models comprising at least a first machine learning model trained via a first third-party workspace and a second machine learning model trained via a second third-party workspace.

6. The computer-implemented method of claim 1, wherein the search query comprises free text search data that is parseable to map to the embedding space.

7. The computer-implemented method of claim 1, wherein the at least one workspace data hook dynamically retrieves the at least one data artifact via the at least one third-party workspace in real-time during training of the machine learning model.

8. The computer-implemented method of claim 1, wherein the at least one workspace data hook retrieves the at least one data artifact via the at least one third-party workspace upon initiation of publication of the machine learning model to a model centralization system.

9. The computer-implemented method of claim 1, wherein the model centralization system maintains a first-party workspace providing access to the at least one third-party workspace.

10. The computer-implemented method of claim 1, wherein generating the embedded representation of the machine learning model based on the at least one data artifact comprises:
applying, by the one or more processors, at least a portion of the at least one data artifact to a clustering model, wherein the clustering model is specially configured to generate N different clusters of machine learning models defined within the embedding space, and wherein the machine learning model is assigned to a particular cluster based on the at least one data artifact.

11. The computer-implemented method of claim 1, wherein generating the embedded representation of the machine learning model based on the at least one data artifact comprises:
applying, by the one or more processors, at least a portion of the at least one data artifact to an embedding model, wherein the embedding model is specially configured to map an embedded representation of the machine learning model to a particular location in the embedding space based on the portion of the at least one data artifact.

12. A system comprising at least one memory and at one or more processors communicatively coupled to the at least one memory, the by one or more processors configured to:
receive, by the one or more processors and automatically via at least one workspace data hook, at least one data artifact associated with training of at least a machine learning model trained utilizing at least one third-party workspace
wherein the at least one workspace data hook integrates with the at least one third-party workspace;
generate, by the one or more processors, an embedded representation of the machine learning model based on the at least one data artifact; and
store, by the one or more processors, the embedded representation of the machine learning model in an embedding space shared with at least one other embedded representation associated with at least one other machine learning model.

13. The system of claim 12, further configured to:
receive, by the one or more processors, a search query;
identify, by the one or more processors and based on processing the search query, at least one stored machine learning model, wherein the at least one stored machine learning model is retrieved based on at least one embedded representation of the at least one stored machine learning model in the embedding space; and
retrieve the at least one stored machine learning model in response to the search query.

14. The system of claim 13, further configured to:
cause, by the one or more processors, rendering of a user interface comprising at least one indication of the at least one stored machine learning model.

15. The system of claim 13, wherein to identify the at least one stored machine learning model, further configured to:
generate, by the one or more processors, a query embedded location by applying the search query to a query embedding model; and
determine, by the one or more processors, the at least one embedded representation of the at least one stored machine learning model is proximate to the query embedded location.

16. The system of claim 12, wherein the at least one workspace data hook dynamically retrieves the at least one data artifact via the at least one third-party workspace in real-time during training of the machine learning model.

17. The system of claim 12, wherein the at least one workspace data hook retrieves the at least one data artifact via the at least one third-party workspace upon initiation of publication of the machine learning model to a model centralization system.

18. The system of claim 12, wherein to generate the embedded representation of the machine learning model based on the at least one data artifact, further configured to:
apply, by the one or more processors, at least a portion of the at least one data artifact to a clustering model, wherein the clustering model is specially configured to generate N different clusters of machine learning models defined within the embedding space, and wherein the machine learning model is assigned to a particular cluster based on the at least one data artifact.

19. The system of claim 12, wherein to generate the embedded representation of the machine learning model based on the at least one data artifact, the system is further configured to:
apply, by the one or more processors, at least a portion of the at least one data artifact to an embedding model, wherein the embedding model is specially configured to map an embedded representation of the machine learning model to a particular location in the embedding space based on the portion of the at least one data artifact.

20. At least one non-transitory computer-readable storage medium having instructions that, when executed by one or more processors, cause the one or more processors to:
receive, by the one or more processors and automatically via at least one workspace data hook, at least one data artifact associated with training of at least a machine learning model trained utilizing at least one third-party workspace
wherein the at least one workspace data hook integrates with the at least one third-party workspace;
generate, by the one or more processors, an embedded representation of the machine learning model based on the at least one data artifact; and
store, by the one or more processors, the embedded representation of the machine learning model in an embedding space shared with at least one other embedded representation associated with at least one other machine learning model.
